(19) United States
(12) Patent Application Publication
(10) Pub. No.: US 2026/0084083 A1
(43) Pub. Date: Mar. 26, 2026

(54) FILTERS AND FILTER ASSEMBLIES WITH CANTED OPENINGS, COLLECTORS AND METHODS OF USE

(71) Applicant: Donaldson Company, Inc., Bloomington, MN (US)

(72) Inventors: Stephan A. Graham, Minneapolis, MN (US); Massimo Movia, Tervueren (BE); Iman Vezvaei, Brussels (BE); David V. Gutman, Brussels (BE); Eric W. E. Collin, Bilzen (BE); Steven A. Johnson, Williams, MN (US); Benny J. B. Mombaerts, Boortmeerbeek (BE); David L. Van Eylen, Heverlee (BE)

(21) Appl. No.: 19/111,423

(22) PCT Filed: Sep. 13, 2023
(86) PCT No.: PCT/US2023/032590

§ 371 Date: Mar. 13, 2025

Related U.S. Application Data
(60) Provisional application No. 63/406,581, filed on Sep. 14, 2022.

(51) Int. Cl. B01D 46/04; B01D 46/00; B01D 46/02; B01D 46/52; B01D 46/58; B01D 46/71

(52) U.S. Cl. CPC B01D 46/04; B01D 46/0005; B01D 46/023; B01D 46/521; B01D 46/58; B01D 46/71; B01D 2271/02; B01D 2275/206

(57) ABSTRACT

Filters having canted openings, filter assemblies including the filters, filter supports, collectors, collectors with reduced profile clean air chambers, and methods of using the same are described herein.

Filters having canted openings, filter assemblies including the filters, filter supports, collectors, collectors with reduced profile clean air chambers, and methods of using the same are described herein.

Many industries encounter particulate matter suspended in the atmosphere. In some industries, this particulate matter is a valuable product (for example, starch), and it would be beneficial if the suspended particulate matter could be recovered and reintroduced into the process. For other industries (for example, metal or wood working), it may be desirable to remove the particulate matter from the air in order to, e.g., provide a cleaner working environment.

Some collectors for cleaning an air or other gas streams laden with particulate matter include filters constructed of filter media, for example, fabric, pleated paper and/or fabric, etc. Gas (e.g., air, etc.) contaminated with particulate matter passes through the filters with the particulate matter being captured and retained by the filters. In some collectors (sometimes referred to as “insertable collectors”), the filters may be suspended within a structure (e.g., a bin, silo, etc.) to filter particulates from air removed from the structure as the structure is filled. In other collectors (sometimes referred to as “cased collectors”), the filters may be located within a dirty air chamber in a housing, with gas containing particulate matter delivered into the dirty air chamber so that the particulate matter can be captured by the filters while the gas passes through the filters into a clean air chamber.

In either case, the collectors include a structure typically referred to as a tubesheet with apertures formed in the tubesheet to receive and retain the filters while preventing the passage of particulate matter from a first volume to a second volume. In an insertable collector, the first volume is the interior volume of a structure in which an insertable collector is installed while the second volume is, e.g., ambient atmosphere (which may be within a building or merely not inside the structure into which the bags are inserted). In a cased collector, the tubesheet typically separates a dirty air chamber from a clean air chamber, the gas carrying entrained particulate matter being delivered into the dirty air chamber and clean/filtered gas entering a clean air chamber after passing through the filters that remove particulate matter from the gas.

Some examples of collectors are described in the following documents: U.S. Pat. No. 3,942,962 (Duyckinck), U.S. Pat. No. 4,218,227 (Frey), U.S. Pat. No. 4,424,070 (Robinson), U.S. Pat. No. 4,436,536 (Robinson), U.S. Pat. No. 4,443,237 (Ulvestad), U.S. Pat. No. 4,445,915 (Robinson), U.S. Pat. No. 4,661,131 (Howeth), U.S. Pat. No. 5,207,812 (Tronto et al.), U.S. Pat. No. 4,954,255 (Muller et al.), U.S. Pat. No. 5,222,488 (Forsgren), U.S. Pat. No. 5,211,846 (Kott et al.), U.S. Pat. No. 5,730,766 (Clements), U.S. Pat. No. 6,090,173 (Johnson et al.), U.S. Pat. No. 6,902,592 (Green et al.), and U.S. Pat. No. 7,641,708 (Kosmider et al.).

As the filters capture particulate matter, flow through the filters is inhibited and periodic cleaning of the filters can be performed to increase air flow through the collector. Cleaning can be accomplished by periodically pulsing a brief jet of pressurized air into the interior of the filter to reverse the flow through the filter, causing the collected particulate matter to be driven off of the filter. Pressurized air (or any other suitable gas) may be directed into pulse collectors as described in, for example, U.S. Pat. No. 3,942,962 (Duyckinck), U.S. Pat. No. 4,218,227 (Frey), U.S. Pat. No. 6,090,173 (Johnson et al.), U.S. Pat. No. 4,395,269, U.S. Pat. No. 6,902,592 (Green et al.), U.S. Pat. No. 7,641,708 (Kosmider et al.), and US Patent Application Publication US 2006/0112667 A1.

### SUMMARY

Filters having canted openings, filter assemblies including the filters and filter supports, filter supports, collectors having canted tubesheets for use with the filters and filter assemblies; and collectors with reduced profile clean air chambers are described herein. Methods of using the collectors, filters, filter supports, and filter assemblies are also described.

In one or more embodiments, the filters described herein include an envelope-shaped filter body having a closed end a filter seal attached to the open end of the filter body. One edge of the envelope-shaped filter body is shorter than the opposite edge of the envelope-shaped filter body such that the open end of the filter body and the filter seal attached thereto can be described as having a canted orientation relative to a filter axis extending between the open end and the closed end of the filter body (the filter axis being generally aligned with the edges of the envelope-shaped filter body). Filters having a canted or angled opening as described herein have, as compared to conventional filter bags, an enlarged opening and seal located around the opening as compared to conventional filters in which the opening is oriented generally perpendicular to a filter axis extending along a length of the filter.

One advantage is that the filters with enlarged openings fit within and seal around larger tubesheet apertures. Those larger tubesheet apertures allow for, in many instances, easier placement and removal of filters within those larger tubesheet apertures because the filter body is generally smaller than the larger tubesheet aperture. That size difference provides extra clearance between the filter body and the tubesheet aperture. The extra clearance can, for example, reduce the potential for damage to the filter body as the filter is advanced through the tubesheet aperture.

With respect to filters in which the filter body is in the form of an envelope-shaped filter bag, the enlarged opening and corresponding seal may allow for easier advancement of the filter body over a support cage used to support the filter bag/body as described herein.

Although the entire filter bag could be enlarged to make installing the filter bag on a cage easier, an enlarged filter bag would result in filter bags that do not fit as tightly on the support cages as described herein. That looser fit would be expected to decrease pulse cleaning performance and/or filter bag life.

In particular, pulse cleaning of the filter bags on support cages as described herein can be improved by fitting the filter bags tightly on the support cages of the filter assemblies. The increased tautness of the tighter fitted filter media results in increases in the rapid acceleration associated with pulse cleaning of the filter bags (sometimes referred to as “bag snap”). The increased rapid outward acceleration may result in increased dislodgment of particulate matter collected on the filter bags, with the dislodged particulate matter falling into a hopper of a collector under the force of gravity.

In addition to improving pulse cleaning performance, tighter fitting filter bag/support cage combinations may also improve filter bag life by reducing filter bag wear caused by excessive movement between support cages and looser fitting filter bags during pulse cleaning.

Yet another advantage that may be attributed to tighter fitting filter bag/cage combinations is that spacing between adjacent filter bags in the dirty air chamber of a collector may be reduced without causing corresponding reductions in pulse cleaning performance. That tighter spacing between adjacent filters can result in a corresponding reduction in the size of the collector as a whole. Smaller collectors that provide the same (or better) filtering capacity as larger collectors can be an important factor when available space in a facility is limited.

The filters, filter assemblies, and collectors described herein may be particularly useful for industrial air filter applications in which particulate matter must be removed from relatively large volumes of dirty air. As such, the filters and filter assemblies must be sized to handle those air volumes and the particulate matter associated with the volumes. Generally, the filters described herein may have a filter length measured from the opening to the closed end of the filter body that is 0.3 meters or more, 0.5 meters or more, or even 1 meter or more. The associated filter body height (measured transverse to the length of the filter) may be 0.2 meters or more, 0.3. meters or more, 0.4 meters or more, or 0.5 meters or more.

In a first aspect, one or more embodiments of a collector for removing particulate matter from gas as described herein includes: a tubesheet comprising a clean face and a dirty face; a housing operably attached to the tubesheet, wherein the housing defines a clean air volume bounded in part by the tubesheet, wherein the clean face of the tubesheet faces the clean air volume; a plurality of apertures formed through the tubesheet, wherein each aperture of the plurality of apertures comprises an elongated aperture comprising a length extending along an aperture axis that is greater a width of the aperture measured in a direction transverse to the aperture axis, wherein, for each aperture of the plurality of apertures, a distance between the clean face of the tubesheet surrounding each aperture and a reference plane oriented transverse to the central pulse axis passing through the aperture changes when moving along the aperture axis; a pulse apparatus located in the clean air volume, the pulse apparatus configured to deliver pulsed gas through the plurality of apertures in the tubesheet, wherein the pulse apparatus defines a central pulse axis extending through each aperture of the plurality of apertures in the tubesheet. The collector further includes a filter positioned in each aperture of the plurality of apertures, wherein each filter comprises a filter body attached to a filter seal, and wherein the filter body comprises an envelope-shaped filter body that comprises filter media defining an interior volume within the filter, the filter body comprising an open end and a closed end, the filter body extending along a filter axis that extends between the open end and the closed end of the filter body, the filter body defining a first major side and a second major side, wherein the first major side and the second major side are defined by the closed end and the open end of the filter body when moving along the filter axis and wherein the first major side and the second major side are further defined by a first edge and a second edge when moving along the filter axis between the open end and the closed end, the first edge and the second edge extending from the closed end to the open end of the filter body; wherein the filter seal is positioned around a perimeter of the open end of the filter body and compressed against the clean face of the tubesheet to form a seal with the clean face of the tubesheet when the filter is installed in a selected aperture of the plurality of apertures such that gas passing into the interior volume must pass through the filter media or through the filter opening; wherein, for each aperture of the plurality of apertures, the aperture axis and the reference plane oriented transverse to the central pulse axis passing through the aperture form an included angle of 5 degrees or more, 10 degrees or more, 15 degrees or more, 20 degrees or more, 25 degrees or more, 30 degrees or more, or 45 degrees or more.

In one or more embodiments of a collector according to the first aspect, for each aperture of the plurality of apertures, the included angle between the aperture axis and the reference plane is 60 degrees or less, 45 degrees or less, 30 degrees or less, or 20 degrees or less.

In one or more embodiments of a collector according to the first aspect, the first edge of the filter body is shorter than the second edge of the filter body.

In one or more embodiments of a collector according to the first aspect, a length of the first edge of the filter body between the closed end and the filter seal is greater than a height of the filter body measured between the first edge and the second edge along the filter height axis.

In one or more embodiments of a collector according to the first aspect, the seal axis forms an included angle with the filter axis of less than 90 degrees, 85 degrees or less, 80 degrees or less, 75 degrees or less, 70 degrees or less, 65 degrees or less, 60 degrees or less, or 45 degrees or less. In one or more embodiments, the included angle between the seal axis and the filter axis is 45 degrees or more, 60 degrees or more, 65 degrees or more, 70 degrees or more, or 75 degrees or more.

In one or more embodiments of a collector according to the first aspect, the closed end of the filter extends along a closed end axis that is transverse to the filter axis and aligned with the filter height axis.

In one or more embodiments of a collector according to the first aspect, the filter body comprises a filter body height measured between the first edge and the second edge along the filter height axis, and wherein the filter body comprises a filter body width measured between the first major side and the second major side of the filter body in a direction that is transverse to both the filter axis and the filter height axis, wherein the filter body width is 0.25 or less, 0.2 or less, or 0.1 or less times the filter body height.

In one or more embodiments of a collector according to the first aspect, at least one filter positioned in an aperture of the plurality of apertures includes a support cage of a filter support is positioned in the interior volume of the filter, the support cage attached to and extending away from a seal support along a cage axis aligned with the filter axis when the support cage is located in the interior volume of the filter and the filter seal is in contact with the seal support, wherein the seal support comprises a support aperture aligned with the filter opening and the aperture in the tubesheet when the support cage is located within the interior volume of the filter, and wherein the filter seal is compressed against the clean face of the tubesheet between the tubesheet and a filter side of the seal support such that gas passing into the interior volume through the filter opening passes through the support aperture of the seal support, and, optionally, wherein the support cage comprises a distal end proximate the closed end of the filter body when the filter seal is in contact with the seal support, wherein, when the support cage is located in the interior volume of the filter, the support cage comprises a first strut located proximate the first edge of the filter body and a second strut located proximate the second edge of the filter body, wherein the first strut extends from the seal support to a distal end proximate the closed end of the filter and the second strut extends from the seal support to a distal end proximate the closed end of the filter.

In one or more embodiments of a collector according to the first aspect, the filter body comprises pleated filter media comprising pleats extending along the filter body from the filter seal to the closed end or a plurality of filter tubes.

In a second aspect, one or more embodiments of a filter as described herein includes a filter body attached to a filter seal. The filter body comprises an envelope-shaped filter body that comprises filter media defining an interior volume within the filter, the filter body comprising an open end and a closed end, the filter body extending along a filter axis that extends between the open end and the closed end of the filter body, the filter body defining a first major side and a second major side, wherein the first major side and the second major side are defined by the closed end and the open end of the filter body when moving along the filter axis and wherein the first major side and the second major side are further defined by a first edge and a second edge when moving along the filter axis between the open end and the closed end, the first edge and the second edge extending from the closed end to the open end of the filter body, wherein the filter body comprises pleated filter media comprising pleats extending along the filter body from the filter seal to the closed end or a plurality of filter tubes; wherein the filter seal is positioned around a perimeter of the open end of the filter body and configured to form a seal with a seal surface when the filter is installed in an aperture of a tubesheet such that gas passing into the interior volume must pass through the filter media or through the filter opening; and wherein the first edge of the filter body is shorter than the second edge of the filter body.

In one or more embodiments of a filter according to the second aspect, the filter seal comprises an elongate shape comprising a seal length measured along a seal axis extending between a first end of the filter seal proximate the first edge of the filter body and a second end of the filter seal proximate the second edge of the filter body, wherein the seal length is greater than a filter body height measured between the first edge and the second edge along the filter height axis; and/or wherein a length of the first edge of the filter body between the closed end and the filter seal is greater than a height of the filter body measured between the first edge and the second edge along the filter height axis.

In a third aspect, one or more embodiments of a filter as described herein includes a filter body attached to a filter seal. The filter body comprises an envelope-shaped filter body that comprises filter media defining an interior volume within the filter, the filter body comprising an open end and a closed end, the filter body extending along a filter axis that extends between the open end and the closed end of the filter body, the filter body defining a first major side and a second major side, wherein the first major side and the second major side are defined by the closed end and the open end of the filter body when moving along the filter axis and wherein the first major side and the second major side are further defined by a first edge and a second edge when moving along the filter axis between the open end and the closed end, the first edge and the second edge extending from the closed end to the open end of the filter body, wherein the filter body comprises pleated filter media comprising pleats extending along the filter body from the filter seal to the closed end or a plurality of filter tubes; wherein the filter seal is positioned around a perimeter of the open end of the filter body and configured to form a seal with a seal surface when the filter is installed in an aperture of a tubesheet such that gas passing into the interior volume must pass through the filter media or through the filter opening; wherein the filter seal comprises an elongate shape comprising a seal length measured along a seal axis extending between a first end of the filter seal proximate the first edge of the filter body and a second end of the filter seal proximate the second edge of the filter body, wherein the seal length is greater than a filter body height measured between the first edge and the second edge along the filter height axis; and wherein the seal axis forms an included angle with the filter axis of less than 90 degrees, 85 degrees or less, 80 degrees or less, 75 degrees or less, 70 degrees or less, 65 degrees or less, 60 degrees or less, or 45 degrees or less.

In one or more embodiments of a filter according to the second or third aspect, the seal axis forms an included angle with the filter axis of less than 90 degrees, 85 degrees or less, 80 degrees or less, 75 degrees or less, 70 degrees or less, 65 degrees or less, 60 degrees or less, or 45 degrees or less; and wherein, optionally, the included angle between the seal axis and the filter axis is 45 degrees or more, 60 degrees or more, 65 degrees or more, 70 degrees or more, or 75 degrees or more.

In one or more embodiments of a filter according to the second or third aspect, the closed end of the filter extends along a closed end axis that is transverse to the filter axis and aligned with the filter height axis; and/or the filter body comprises a filter body height measured between the first edge and the second edge along the filter height axis, and wherein the filter body comprises a filter body width measured between the first major side and the second major side of the filter body in a direction that is transverse to both the filter axis and the filter height axis, wherein the filter body width is 0.25 or less, 0.2 or less, or 0.1 or less times the filter body height.

Methods of using filters, filter supports, collectors, and filter assemblies are also described herein.

If used herein, relational terms such as above, below, top, bottom, etc. are (unless otherwise specified in this description and/or the claims) used only to facilitate description of the various features of the apparatus and methods described herein and should not be construed to require any specific orientation of the apparatus and/or the methods described herein unless explicitly required otherwise.

When used herein, the term “aligned with” (and variations thereof) as used in connection with various components, axes, directions of travel, etc. includes both parallel and generally parallel arrangements. For example, two axes (or other components, features, etc.) may be described as “aligned with” when the axes (or other components, features, etc.) are both perfectly parallel with each other or nearly parallel, e.g., the axes (or other components, features, etc.) may form an angle with each other that is greater than 0 degrees but 5 degrees or less.

When used herein, the term “transverse” (and variations thereof) as used in connection with the relative orientation of axes (and/or other components, features, etc.) includes orientations that are perpendicular (i.e., that form a 90 degree angle) as well as orientations in which the axes (and/or other components, features, etc.) are nearly perpendicular, e.g., the axes (and/or other components, features, etc.) may be oriented at angles that are 5 degrees or less off of perpendicular.

If used herein, the term “substantially” has the same meaning as “significantly,” and can be understood to modify the term that follows by at least about 75%, at least about 90%, at least about 95%, or at least about 98%. The term “not substantially” as used herein has the same meaning as “not significantly,” and can be understood to have the inverse meaning of “substantially,” i.e., modifying the term that follows by not more than 25%, not more than 10%, not more than 5%, or not more than 2%.

Numeric values used herein include normal variations in measurements as expected by persons skilled in the art and should be understood to have the same meaning as “approximately”and to cover a typical margin of error, such as ±5 % of the stated value.

Terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

The words “preferred” and “preferably” (where used) refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,”“an,”“the,”“at least one,”and “one or more”are used interchangeably herein.

In a similar manner, term such as “first” and “second” may be used herein to describe various elements. However, such terms are used merely to distinguish one of the elements from the other. It is further understood that the description of any particular element as being operatively attached, connected, and/or coupled to another element may indicate that the elements are either directly attached, connected, and/or coupled to one another, or are indirectly attached, coupled, and/or connected to one another via intervening elements.

Unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements.

The above summary is not intended to describe each embodiment or every implementation of the filtration system, filters, filter assemblies, filter supports, collectors, and related methods described herein. Rather, a more complete understanding of the invention will become apparent and appreciated by reference to the following Description of Illustrative Embodiments and claims in view of the accompanying figures of the drawing.

### BRIEF DESCRIPTION OF THE VIEWS OF THE DRAWING

Illustrative embodiments will be further described with reference to the figures of the drawing, wherein:

FIG. 1 is a side view of one illustrative embodiment of a filter having a canted or enlarged opening as described herein.

FIG. 2 is a view of the opening of the filter of FIG. 1 taken along a viewing axis aligned with the filter axis 11 in FIG. 1 (looking towards the filter 10 from above).

FIG. 3 is a cross-sectional view of the filter of FIGS. 1 and 2 taken along line 3-3 in FIG. 2.

FIGS. 4-5 depict alternative illustrative embodiments of filters having enlarged/canted openings and corresponding seals as described herein.

FIG. 6 depicts one illustrative embodiment of a filter support for use with a filter as described herein.

FIG. 7 is cross-sectional view of the filter support of FIG. 6 taken along line 7-7 in FIG. 6.

FIG. 8 depicts placement of the filter support of FIG. 6 into one illustrative embodiment of a filter as described herein.

FIG. 9 depicts the filter and filter support of FIG. 8 after assembly.

FIG. 10 is a perspective view of another illustrative embodiment of a filter support including a venturi as described herein.

FIGS. 11 and 12 are additional views of the filter support depicted in FIG. 10.

FIG. 13 depicts one alternative illustrative embodiment of a filter support including a venturi as described herein.

FIG. 14 depicts the filter support of FIG. 13 in a view taken along cage axis 241 from above.

FIG. 15 depicts one alternative illustrative embodiment of a filter support including a detachable venturi as described herein.

FIG. 16 depicts the venturi of FIG. 15 in a view taken along cage axis 341 from above the venturi and filter support.

FIG. 17 depicts the seal support of the filter support depicted in FIG. 15 in a view taken along cage axis 341 from above the filter support and below the venturi.

FIG. 18 depicts one illustrative embodiment of a collector having a canted tubesheet as described herein.

FIG. 19 is a view of the collector of FIG. 18 taken along a collector axis 61.

FIG. 20 depicts the collector of FIGS. 18-19 after placement of a set of filters and pulse apparatus within the collector.

FIG. 21 depicts placement of a filter in an aperture of the tubesheet of the collector of FIGS. 18-20 (with extraneous features removed for clarity).

FIG. 22 depicts another illustrative embodiment of a collector as described herein.

FIGS. 23-25 depict one illustrative embodiment of a tubesheet adapter for use in collectors as described herein.

FIGS. 26-28 depict illustrative embodiments of alternative tubesheets that may be used in one or more collectors as described herein.

FIG. 29 depicts one illustrative embodiment of a cased collector as described herein.

FIG. 30 depicts one illustrative embodiment of an insertable collector as described herein.

FIG. 31 is a schematic view of the collector according to one embodiment;

FIG. 32 is a perspective view of one prior art collector 1 (on the left side) and a collector according to one embodiment of the invention (on the right);

FIG. 33 is a perspective view of the collectors of FIG. 32 with some internal components exposed;

FIG. 34 is a side view of the illustrative embodiment of collector described herein and depicted in FIGS. 32-33;

FIG. 35 is an enlarged partial side view of the collector of FIG. 34; and

FIGS. 36A-36C are enlarged partial side views of the collector of FIGS. 34-35, illustrating removal and/or insertion of jet tubes with respect to the collector.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DESCRIPTION OF ILLUSTRATIVE EMBODIMENTS

In the following detailed description of illustrative embodiments, reference is made to the accompanying figures of the drawing which form a part hereof. It is to be understood that other embodiments, which may not be described and/or illustrated herein, may be used and structural changes may be made without departing from the scope of the present invention.

Unless otherwise indicated, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure. These terms are used only to simplify the description, however, and not to limit the interpretation of any embodiment described.

It should be understood that features of the illustrative embodiments of the filtration systems described herein that are not explicitly recited in the claims are optional, e.g., features such as the number of filters, access openings, shape and/or size of the housing, etc. may be changed in one or more alternative embodiments of filtration systems as described herein. It should also be understood that, other than a filter media in the filters, the components of the filtration systems described herein will typically be constructed of materials (e.g., metals, polymers, ceramics, etc.) that are impermeable to air.

Furthermore, although the illustrative filter 10 is depicted as having a constant size (e.g., width, height, diameter, etc.) between the proximal and distal ends, it may vary in size, and further the optional pulse collectors used in one of more alternative embodiments of the filter systems described herein may change in size between their inlets and outlets, as described in the incorporated reference(s) above.

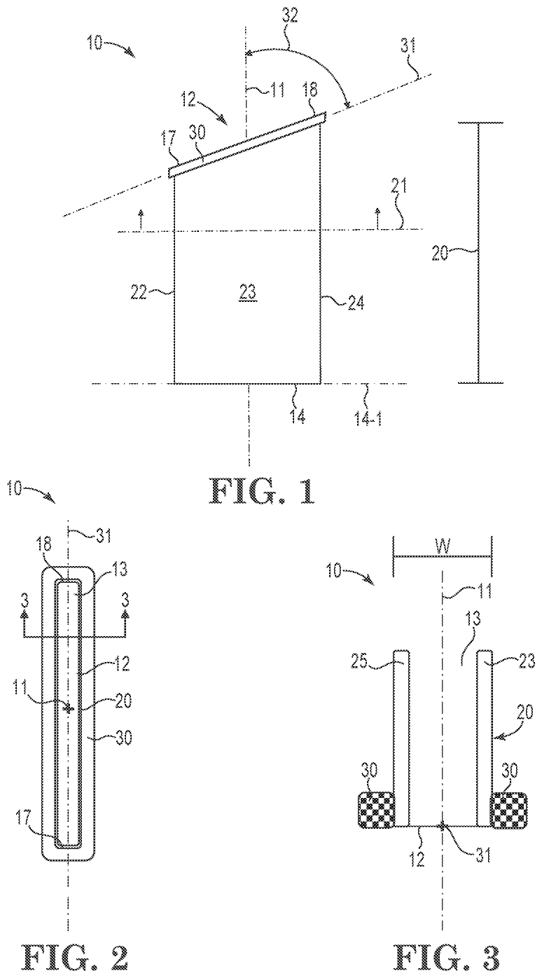

FIGS. 1-3 depict various views of one illustrative embodiment of a filter as described herein. In FIG. 1, the filter 10 includes a filter body 20 including an open end 12 and a closed end 14. A filter body 20 extends from the open end 12 to the closed end 14 along a filter axis 11 extending between the open end 12 and the closed end 14.

The body 20 of the filter 10 can be described as an envelope-shaped filter body with filter media defining an interior volume within the filter 10. As an envelope-shaped filter body 20, the body 20 as a first major side 23 and a second major side 25 positioned across the interior volume 13 (see, e.g., FIG. 3). The first major side 23 and second major side 25 are defined by the closed end 14 and the open end 12 of the filter body 20 when moving along the filter axis 11. The first major side 23 and second major side 25 of the filter body 20 are further defined by a first edge 22 and a second edge 24 with the first edge 22 and the second edge 24 being, in the depicted embodiment, generally aligned with the filter axis 11. In one or more alternative embodiments, however, the edges 22 and 24 of the filter body 20 may or may not be generally aligned with the filter axis 11.

As an envelope-shaped filter body 20, the filter body may be described as having a filter body height measured between the first edge 22 and the second edge 24 along the filter height axis 21. The envelope-shaped filter body 20 may also be described as having a filter body width (see dimension W in FIG. 3) measured between the first major side 23 and the second major side 25 of the filter body 20 in a direction that is transverse to both the filter axis 11 and the filter height axis 21. In one or more embodiments, the envelope-shaped filter body width may be 0.25 or less, 0.2 or less, or 0.1 or less times the filter body height.

Although not required, the depicted illustrative embodiment of filter 10 includes a closed end 14 that extends along a closed end axis 14-1 that is transverse to the filter axis 11 and aligned with a filter height axis 21 extending between the first edge 22 and the second edge 24 (also in a direction transverse to the filter axis 11).

Because the filter body 20 is an envelope-shaped filter body, the first major side 23 and second major side 25 of the filter body 20 are may be described as being operably attached to each other along the closed end 14 of the filter body 20 as well as along the first edge 22 and second edge 24 to enclose the interior volume 13 of the filter such that air (or any other gas) entering into or leaving the interior volume 13 must either pass through the open end 12 or through the filter media defining the interior volume 13.

In one or more embodiments, the filter axis 11 may be described as being coincident with a central axis of the filter body 20, where the central axis/filter axis 11 extends through center of the filter body 20 such that the central axis/filter axis 11 contains the geometric centers of cross-sections of the filter body 20 taken in planes oriented perpendicular to the central axis/filter axis 11.

With reference to FIGS. 1-3, the filter 10 also includes a filter seal 30 positioned around a perimeter of the open end 12 of the filter body 20. The filter seal 30 is configured to form a seal with a seal surface when the filter 10 is installed in an aperture of a tubesheet such that gas passing into the interior volume 13 must pass through the filter media defining the interior volume or through the open end 12 of the filter body 20. In one or more embodiments of the filters described herein, the filter seal 30 extends around the entire perimeter of the open end 12 as seen in, for example, FIG. 2.

In one or more embodiments, the filter seal 30 may be provided as a discrete component attached to the filter body 20 of the filter 10. The filter seal may, in one or more embodiments, be provided as multiple layers of filter media combined through one or more of stitching, adhesives, thermal welding, chemical welding, etc. The filter seal may include a polymeric component, e.g., a flexible polymeric component. In one or more embodiments, the filter seal may be capable of taking the shape of the filter body 20 of the filter 10. In one or more embodiments, the filter seal may be in the form of a compressible material, e.g., foam (closed cell, open cell, etc.), fabric, filter media, etc. to assist in forming a seal when clamped within a collector as described herein. In one or more embodiments, the filter seal may be formed of a resiliently compressible material capable of returning to its original shape (or nearly its original shape) after compression. In one or more other embodiments, the filter seals may include one or more layers of material that exhibit increased resistance to abrasion and/or tearing. In yet other embodiments, the filter seals use in filters as described herein may be formed of two or more components attached to the filter body through any suitable technique or combination of techniques.

Although the depicted illustrative embodiment of filter 10 includes a filter seal 30 positioned at the open end 12, in one or more embodiments, the filter seal 30 could be positioned proximally from the open end 12 such that the filter seal 30 is located between the open end 12 and closed end 14 but also spaced from the open end 12. One advantage of providing a s filter seal 30 located at the open end 12 is that compression of the filter seal 30 may be more readily obtained when such an arrangement of the filter seal 30 is provided. Compression of the filter seal 30 may be important in forming a proper seal to prevent unwanted passage of particulate matter when using filters as described herein.

One or more embodiments of the filters described herein may be characterized in terms of the lengths of the first edge 22 and second edge 24 of the envelope-shaped filter body 20. In particular, for example, the first edge 22 of the filter body 20 is shorter than the second edge 24 of the filter body 20 when moving along the direction of the filter axis 11. The result of that difference in length between the first edge 22 and the second edge 24 is that the open end 12 and filter seal 30 are oriented at a non-perpendicular angle relative to the filter axis 11. In other words, the open end 12 and the filter seal 30 may be described as being canted or angled relative to the filter axis 11 rather than being perpendicular to the filter axis as is commonly seen in filters.

Although conventional envelope-shaped filters may exhibit minor variations in length between their opposing edges, those differences can be attribute to manufacturing tolerances and do not provide the advantages associated with the differences in edge length and corresponding increases in the sizes of the openings defined by the open ends of the filters at the filter seals of the envelope-shaped filters as described in connection with the present invention (those advantages including easier insertion of a filter support into the interior volume of the filter and/or easier insertion of the filter into a tubesheet aperture as described herein).

In one or more embodiments, the filter seal 30 can be described as having an elongate shape defining a seal length measured along a seal axis 31 extending between a first end 17 of the filter seal 30 proximate the first edge 22 of the filter body 20 and a second end 18 of the filter seal 30 proximate the second edge 24 of the filter body 20. Because the open end 12 and the filter seal 30 are canted or angled relative to the filter axis 11, the seal length as measured between the first end 17 and second end 18 of the filter seal 30 is greater than a filter body height measured between the first edge 22 and the second edge 24 along a filter height axis 21 where the filter height axis 21 is oriented transverse to the filter axis 11.

In one or more embodiments, the seal axis 31 can be described as forming an included angle 32 with the filter axis 11 that is less than 90 degrees, 85 degrees or less, 80 degrees or less, 75 degrees or less, 70 degrees or less, 65 degrees or less, 60 degrees or less, or 45 degrees or less. At a lower end, the included angle formed between the seal axis 31 and filter axis 11 may, in one or more embodiments, be 45 degrees or more, 60 degrees or more, 65 degrees or more, 70 degrees or more, or 75 degrees or more.

Although increasing the size of the bag opening 12/filter seal 30 by decreasing the included angle 32 between the filter axis 11 and the seal axis 31 can make installation of the filter 10 easier, decreasing the included angle 32 would also increase the overall length of the filter 10 as measured along the second edge 24 of the filter body 20 and, therefore, filter 10. That increasing filter length could be expected to cause a corresponding increase in the size of a collector in which filter 10 is installed. Because increases in the overall size of collectors can be a concern, it may be preferred that the included angle 32 between the filter axis 11 and the seal axis 31 be within a range of, for example, 60 degrees to 80 degrees to provide a balance between easier installation and filter length while maintaining pulse cleaning performance and filter life.

As described herein, the canted or angled open end 12 and filter seal 30 provides advantages in terms of the size of the opening defined by the open end 12 and filter seal 30 with that enlarged opening providing advantages when placing support cages or other structures within the interior volume 13 of the filter 10.

For those filters in which a support cage or other interior structure is not required, the enlarged size of the canted or angled open end 12 and filter seal 30 offers the ability to seal or close off a larger aperture in a tubesheet through which the filter 10 is inserted. Because the filter body height as measured between the first edge 22 and the second edge 24 of the filter body is less than the length of the filter seal 30 and, correspondingly, less than the size of the aperture in a tubesheet sealed by the filter seal 30, insertion and removal of the filter 10 from the larger aperture may also be facilitated as described herein.

In one or more embodiments of filters having canted or angled openings and filter seals as described herein, a length of the shorter first edge 22 of the filter body (as measured between the closed end 14 and the filter seal 30) is greater than a height of the filter body 20 measured between the first edge 22 and the second edge 24 along the filter height axis 21. As a result, the filters described herein have a length greater than their height which may, in one or more embodiments, offer additional filtering capacity as compared to shorter filters.

In one or more embodiments of the filters described herein, the filter body 20 may be constructed of generally planar filter media configured to filter air or any other gas passing through the filter media forming the body 20 with particulate matter entrained in the air or other gas being captured within or on the filter media forming the body 20. In general, the filter media may preferably be flexible enough such that the filter media is capable of being flexed during pulse cleaning as described herein with that flexing or movement of the filter media preferably resulting in removal of at least a portion of the particulate matter captured within or on the filter media forming the filter body 20. The construction of such filter media is well known to those skilled in the art and may, for example, include woven materials, nonwoven materials, paper, etc. selected in view of the particulate matter to be collected, airflow requirements, strength requirements, etc. Suitable filter bags may be constructed of one or more layers of filter media, scrim, etc. that includes one or more of polyester, polypropylene, aramid, polyester/polytetrafluoroethylene material in both woven and/or nonwoven constructions, etc.

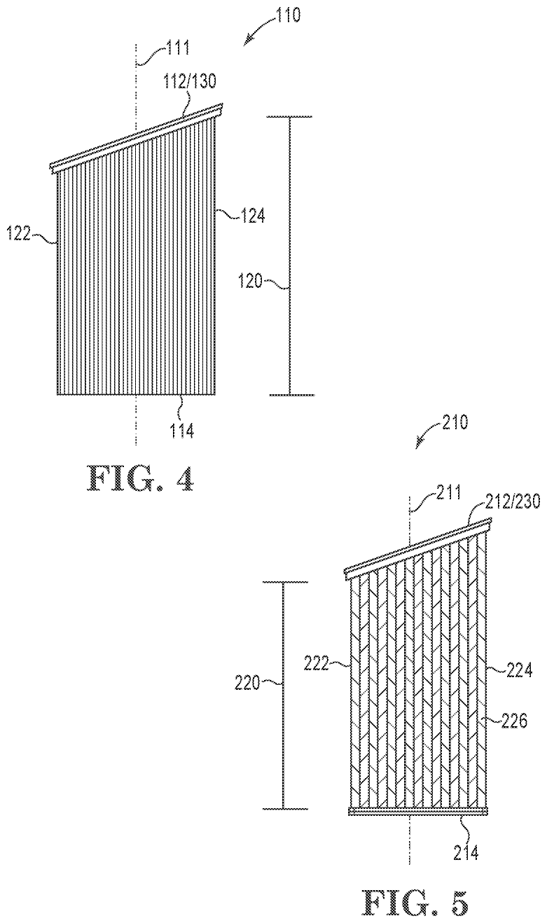

While the filter 10 depicted in FIGS. 1-3 may be constructed of generally planar filter media, FIGS. 4 and 5 depict alternative embodiments of filters having canted or angled open ends and associated filter seals that also provide advantages in the placement and removal of the filters within a collector as described herein.

The illustrative embodiment of filter 110 depicted in FIG. 4 includes a filter body 120 extending along a filter axis 111 between and open end 112 and a closed end 114. The filter body 120 is also envelope-shaped as described in connection with filter 10 and includes a first edge 122 and a second edge 124 extending from the open end 112 to the closed end 114 of the filter 110. Filter 110 also includes a filter seal 130 configured to form a seal with a seal surface when the filter 110 is installed in an aperture of a tubesheet such that gas passing into an interior volume of the filter 110 must pass through the filter media forming the filter body 120 or through the filter opening at open end 112. The filter body 120 is, in the depicted embodiment, formed of a pleated filter media with the pleats extending along the length of the filter body such that the pleats are aligned with the filter axis 111. Any other suitable arrangement of pleated filter media may also be substituted, for example, the pleats may advantageously run in a direction transverse to the filter axis 111 or at any other orientation that provides suitable advantages.

The illustrative embodiment of filter 210 depicted in FIG. 5 includes a filter body 220 extending along a filter axis 211 between open end 212 and closed end 214. The filter body 120 is constructed of a series of filter tubes 226 aligned with the filter axis 211 such that the open end 212 of the filter 210 is a collection of openings of each of the filter tubes 226 while the closed end 214 of the filter 210 is formed by the closed ends of each of the filter tubes 226. The edges of the filter body 220 are formed by the outermost filter tubes with the first edge 222 of filter body 220 being formed by the leftmost filter tube 226 and the second edge 224 of the filter body 220 being formed by the rightmost filter tube 226 in the view depicted in FIG. 5. Filter 210 also includes a filter seal 230 configured to form a seal with a seal surface when the filter 210 is installed in an aperture of a tubesheet such that gas passing into an interior volume of any one of the filter tubes 226 of the filter 210 must pass through the filter media forming one of the filter tubes 226 of the filter body 220 or through a filter tube opening at the open end 212 of the filter body 220.

### Filter Assemblies

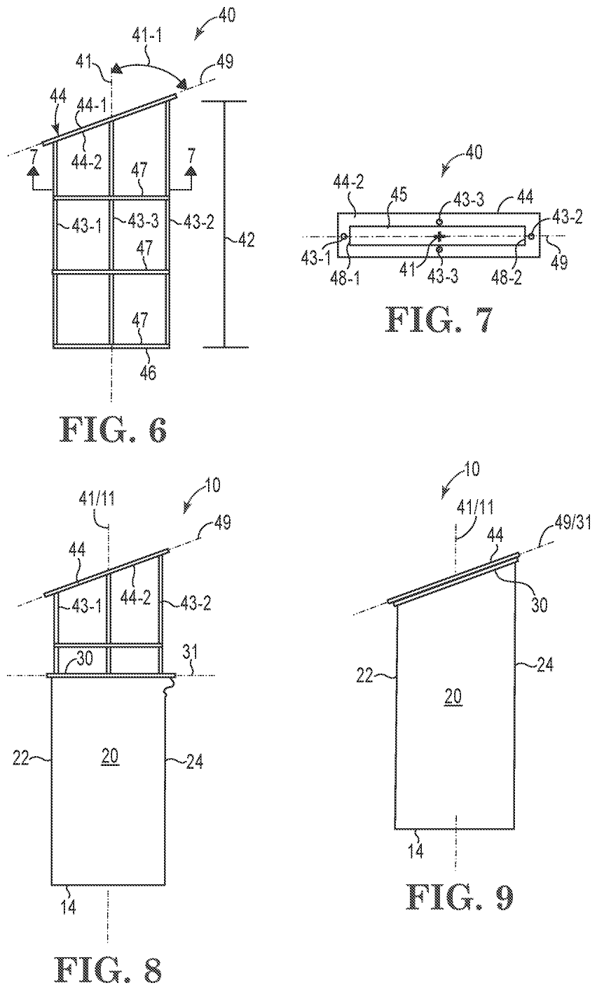

The filter assemblies described herein may be useful for at least some embodiments of the filters described herein. With reference to FIGS. 6-7 with FIG. 7 being a cross-sectional view of FIG. 6 taken along line 7-7 in FIG. 6, one illustrative embodiment of a filter support 40 is depicted, with the depicted filter support 40 includes a support cage 42 and seal support 44. The support cage 42 is configured for placement within the interior volume of one or more embodiments of the filters described herein. In one or more embodiments the support cage comprises struts 43 aligned with a cage axis 41, with the cage axis 41 extending through the seal support 44. In the depicted illustrative embodiment, support cage 42 includes braces 47 extending between the struts 43 aligned with the cage axis 41, including a brace 47 extending between the outermost struts 43 at a distal end 46 of the support cage 42. In the depicted embodiment, the braces 47 extend in a direction transverse to the cage axis 41. The depicted arrangements of struts 43 and braces 47 in support cage 42 provide only one example of a support cage that may be used to support a filter in connection with the filter assemblies described herein.

In the depicted embodiment, strut 43-1 extending between the seal support 44 and distal end 46 of the support cage 42 is shorter than the strut 43-3 located on the opposite side of the support cage 42 and extending from the seal support 44 to the distal end 46. In one or more embodiments, a length of strut 43-1 between the seal support 44 and the distal end of the strut 43-1 (at distal end 46 of the support cage 42) is greater than a height of the support cage 42 measured between the first strut 43-1 and the second strut 43-2 in a direction transverse to the cage axis 41. These relationships may preferably be similar to that found in a filter to be fitted onto the filter support 40 to provide a sufficiently tight fit of the support cage 42 within a complementary filter.

Seal support 44 includes a support aperture 45 formed through the seal support 44 from a clean side 44-1 to filter side 44-2 of seal support 44. In one or more embodiments, the seal aperture has an elongate shape with an aperture length measured along an aperture axis 49 that extends between a first end 48-1 of the support aperture 45 to a second end 48-2 of the support aperture 45. In one or more embodiments, the aperture axis 49 may form an included angle 41-1 with the cage axis 41 of less than 90 degrees, 85 degrees or less, 80 degrees or less, 75 degrees or less, 70 degrees or less, 65 degrees or less, 60 degrees or less, or 45 degrees or less. At a lower end, the included angle between the aperture axis 49 and the cage axis 41 may, in one or more embodiments, be 45 degrees or more, 60 degrees or more, 65 degrees or more, 70 degrees or more, or 75 degrees or more. One range that may be useful could involve included angles 41-1 between the aperture axis 49 and the cage axis 41 of 60 degrees to 80 degrees to provide a balance between ease of use and filter size/filtering capacity of the compatible filters.

In one or more embodiments, the aperture length of the support aperture 45 measured along the aperture axis 49 extending between a first end 48-1 of the support aperture 45 proximate a junction between the first strut 43-1 and the seal support 44 and a second end 48-2 of the support aperture 45 proximate a junction between the second strut 43-2 and the seal support 44 is greater than a support cage height measured between the first strut 43-1 and the second strut 43-2 in a direction transverse to the cage axis 41.

FIG. 8 is a side elevation view of the assembled filter assembly of FIG. 9. In particular, FIG. 8 depicts a filter 10 as depicted in FIGS. 1-3 partially advanced over the support cage 42 of the filter support 40 while FIG. 9 depicts the fully assembled filter assembly including a filter 10 and filter support 40 located within the interior volume of the filter 10.

As seen in FIG. 8, filter seal 30 of the filter 10 is oriented generally perpendicular to the filter axis 11/cage axis 41 so that the enlarged opening if the filter within filter seal 30 can be used to more easily advance the filter 10 over the support cage 42. In the depicted embodiment of filter 10, a portion of the second edge 24 proximate the filter seal 30 is folded or compressed to orient the filter seal 30 generally transverse to the cage axis 41/filter axis 11 as seen in FIG. 8.

The struts of the support cage 42 attached to the seal support 44 extend into the filter body 20 with strut 43-1 being positioned proximate the first edge 22 of the filter body 20 and strut 43-2 on the opposite side of the support cage 42 being positioned proximate the second edge 24 of the filter body 20. In the depicted embodiment, strut 43-1 extending between the seal support 44 and distal end 46 of the support cage 42 is shorter than the strut 43-2 located on the opposite side of the support cage 42 and extending from the seal support 44 to the distal end 46. This relationship is preferably similar to that found in the filter 10 fitted onto the filter support 40.

When the filter 10 is fully fitted onto the filter support 40 as depicted in FIG. 9, filter seal 30 is seated against the filter side 44-2 of the seal support 44 and the closed end 14 of the filter body 20 is positioned proximate the brace 47 extending between struts 43-1 and 43-2 of support cage 42. In this arrangement, the aperture axis 49 is aligned with the seal axis 31 and the cage axis 41 is aligned with the filter axis 11.

As a result, the filter seal 30 (when installed in a collector) is configured to form a seal with the filter side 44-2 of the seal support 44 such that gas passing into the interior volume 13 of the filter 10 through the filter opening defined within filter seal 30 passes through the support aperture 45 of the seal support 44. In one or more embodiments, the seal support 44 may be used to compress the filter seal 30 against the clean-air side of a tubesheet in a collector to form the seal. As used herein, the term “compressed” means that the filter seal 30 has been at least partially deformed between the seal support 44 and a tubesheet.

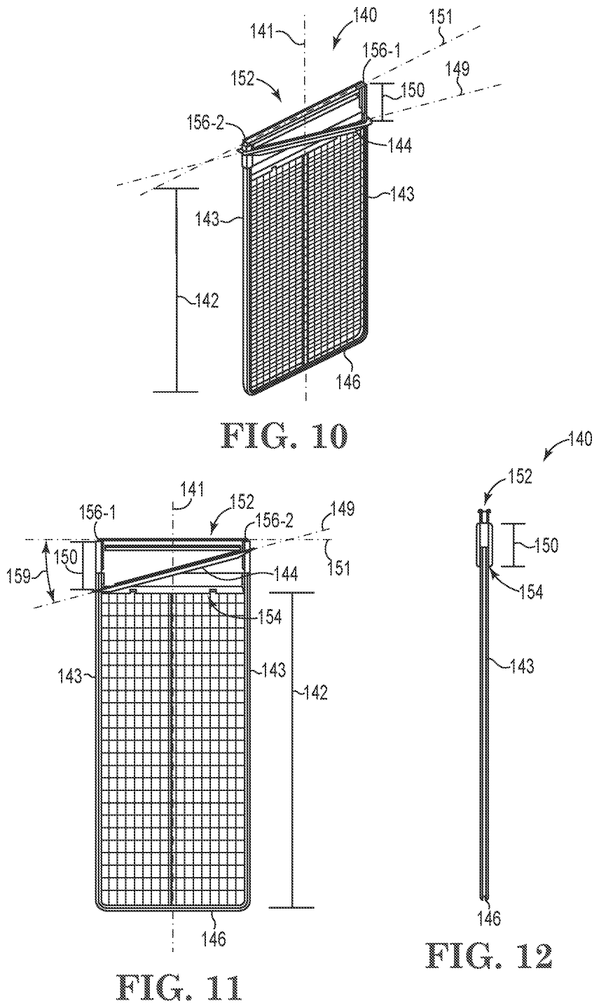

FIGS. 10-12 depict another illustrative embodiment of a filter support that may be used with one or more embodiments of the filters and/or collectors described herein. The filter support 140 includes a seal support 144 and support cage 142. Support cage 142 includes struts 143 that are generally aligned with a cage axis 141 defined by the support cage 142. The struts 143 extend to the distal end 146 of the support cage 142. Seal support 144 is, similar to seal support 44 described in connection with filter support 40, oriented at an angle along an aperture axis 149 with the cage axis 141 and aperture axis 149 forming an included angle as discussed above in connection with filter support 40.

One feature depicted in connection with filter support 140 that is not found in filter support 40 is the addition of a venturi 150 attached to the filter support 140. The venturi 150 is used to collect and direct cleaning pulses of gas into the interior volume of a filter fitted onto the filter support 140 in collectors that use pulse cleaning to drive collected particulate matter off of a filter fitted onto the filter support 140. The venturi 150 extends between a collector opening 152 facing away from the support cage 142 and a filter opening 154 facing the support cage 142. In one or more embodiments, the venturi 150 may be described as extending through the support aperture of the seal support 144. Gas passing into the interior volume of a filter fitted over the support cage 142 (such that the support cage is located within the interior volume of the filter) passes through the venturi 150 before passing into the interior volume of the filter.

In the depicted embodiment, the collector opening 152 of the venturi 150 may be described as an elongate collector opening that extends between a first end 156-1 to a second end 156-2 along a venturi axis 151. The venturi 150 may further be described as having a first depth proximate the first end 156-1 that is greater than a second depth proximate the second end 156-2, where the first depth and the second depth are measured between the collector opening 152 and the seal support 144 when moving along the cage axis 141.

In one or more embodiments, the relationship between the seal support 144 and the collector opening 152 of the venturi 150 can be described using the venturi axis 151 defined by the collector opening 152 and the aperture axis 149 defined by the support aperture in the seal support 144. As discussed herein, the aperture axis 149 extends between first and second ends of the support aperture in the seal support 144 while the venturi axis 151 extends between the first and second ends of the collector opening 152. In one or more embodiments, the venturi axis 151 forms an included angle 159 with the aperture axis of 5 degrees or more, 10 degrees or more, 15 degrees or more, 30 degrees or more, or 45 degrees or more. At the upper end, the included angle between the venturi axis 151 and the aperture axis 149 may, in one or more embodiments, be 60 degrees or less, 45 degrees or less, or 30 degrees or less. One range that may be useful for included angle 159 is 10 degrees to 30 degrees to match the angles of complementary filters that provide a balance between ease of use and filter size/filtering capacity.

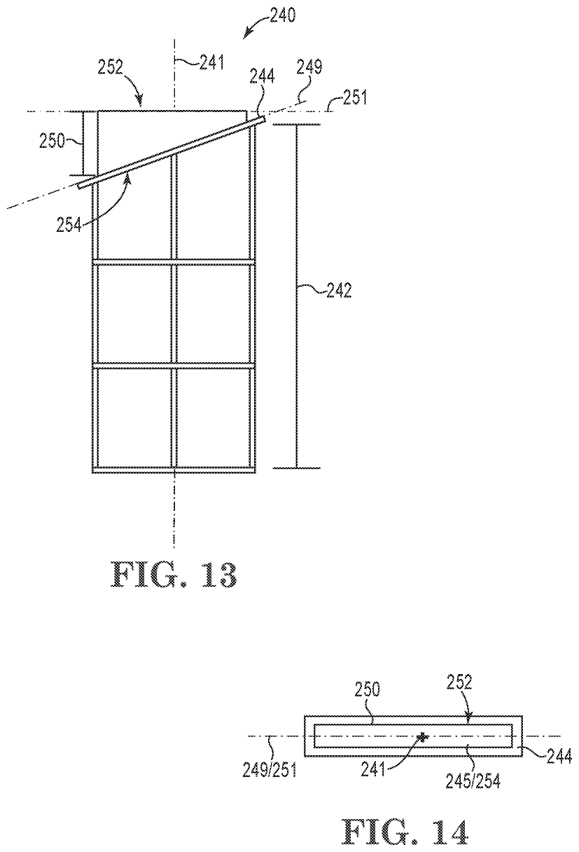

Although, seen in FIG. 11, venturi 150 has a generally rectangular profile in which the collector opening 152 and the filter opening 154 are generally parallel to each other, venturis used in connection with the filters and filter supports described herein may be different. With respect to FIGS. 13-14, one alternative embodiment of a filter support 240 including a venturi 250 is depicted, with the view of FIG. 14 being taken along cage axis 241 depicted in FIG. 13.

Filter support 240 includes a support cage 242 and seal support 244 which may, for example, be very similar to those components as depicted and described in FIGS. 6-7. The venturi 250 attached to seal support 244 includes a collector opening 252 and a filter opening 254, with the filter opening 254 lying on the seal support 244 such that venturi 250 does not extend into the volume defined by the support cage 242.

Both the filter opening 254 at the base of the venturi 250 (where the base of the venturi 250 is located at its junction with seal support 244) and the seal support 244 extend along the aperture axis 249 defined by the support aperture 245 in seal support 244 (with the filter opening 254 and support aperture 245 being, in the depicted illustrative embodiment, coextensive with each other). Furthermore, the collector opening 252 may, in one or more embodiments, extend along a venturi axis 251 that is transverse to the cage axis 241.

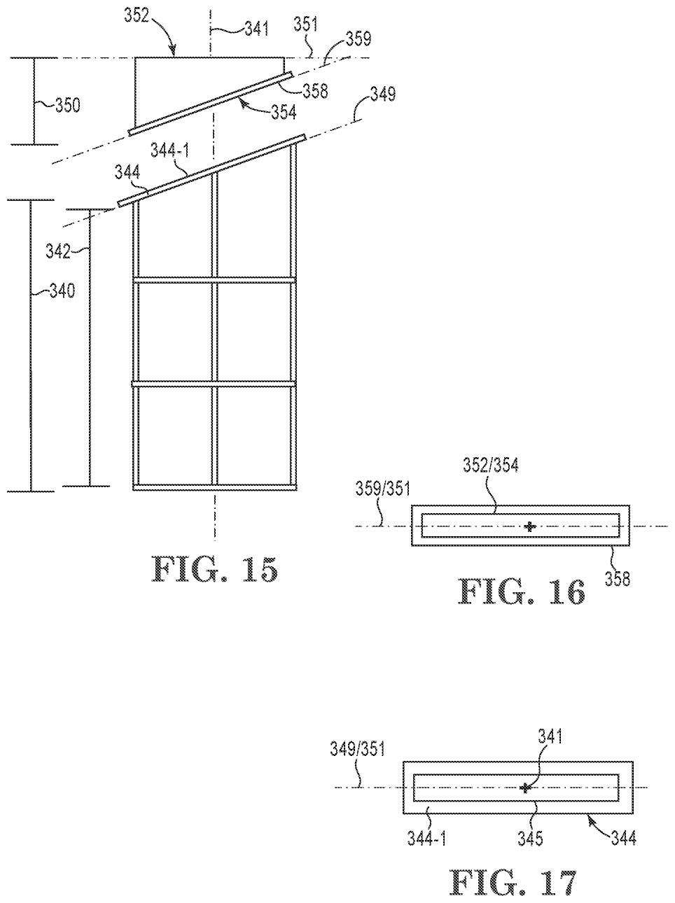

FIGS. 15-17 depicts another alternative embodiment of a filter support 340 and venturi 350 configured to be assembled with the filter support 340. Filter support 340 includes a support cage 342 and seal support 344, with the support cage standard 42 extending along a cage axis 341 away from the seal support 344.

Venturi 350 includes a venturi base 358 facing the clean side 344-1 of the seal support 344. A passageway for pulsed gas extends through the venturi 350 from the collector opening 352 to the filter opening 354 in venturi base 358. Further, venturi base 358 is configured for attachment to the clean side 344-1 of seal support 344 such that pulsed gas passing through the collector passes through the seal aperture 345 (see, e.g., FIG. 17) for delivery to the interior volume of a filter fitted over the support cage 342.

The venturi base 358 of the depicted embodiment of venturi 350 may, in one or more embodiments, be oriented relative to the cage axis 341 along an angle that is the same as the angle formed between the seal support 344 and the cage axis 341.

Furthermore, when the filter support 340 and venturi 350 are assembled together, the collector opening 352 may, in one or more embodiments, extend along a venturi axis 351 that is transverse to the cage axis 341.

One potential advantage of venturis having collector openings defining venturi axes that are oriented relative to the cage axes and seal supports as described herein is that the collector openings, when so arranged, may be oriented generally transverse to a pulse axis defined by pulse apparatus used in collectors in which the filter supports and venturis are installed. That orientation may improve collection of pulsed gas for delivery into the interior volume of filters positioned on the filter supports which can, consequently, enhance pulse cleaning of filters positioned on the filter supports.

### Collectors

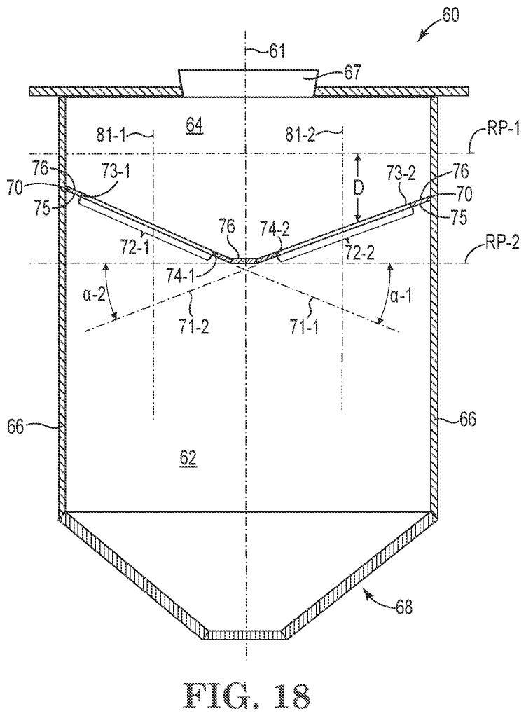

FIGS. 18-30 depict various features of collectors that may be used in one or more embodiments of collectors as described herein to remove particulate matter from a gas stream (e.g., air) in which particulate matter is entrained. The collectors may be particularly adapted to use filters having canted or angled openings as described herein (where those filters may or may not be provided along with a filter support as described herein).

One illustrative embodiment of a collector is depicted in FIGS. 18-21, with FIG. 18 depicting a tubesheet 70 located in a housing defined by walls 66 to define a dirty air volume 62 and a clean air volume 64 with clean air outlet 67 used to remove clean air from the clean air volume of the collector 60. Although not depicted, a dirty air inlet delivers dirty air to the dirty air volume 62. Collector 60 also includes a hopper 68 into which particulate matter moves after dislodgment from filters located in the dirty air volume 62 of collector 60.

Tubesheet 70 may be described as having a dirty face 75 facing the dirty air volume 62 and a clean face 76 facing the clean air volume 64 within the collector 60 noting that “dirty” is used to denote the portion of the collector 60 receiving particulate matter entrained in air or other gases while “clean” is used to denote the portion of the collector 60 into which that air or other gas is delivered after passing through one or more filters in the collector 60.

The depicted tubesheet 70 includes apertures 72-1 and 72-2 (which may be collectively referred to as apertures 72 herein) formed through the tubesheet 70. Each aperture 72 may be described as forming an elongated aperture having a length along an aperture axis that is greater than a width of the aperture measured in a direction transverse to the aperture axis.

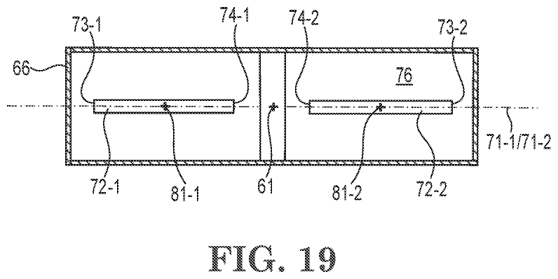

With reference to, for example, FIGS. 18-19, aperture 72-1 extends along aperture axis 71-1 from a first end 73-1 to a second end 74-1 while aperture 72-2 extends along aperture axis 71-2 from a first end 73-2 to a second end 74-2. As seen in, e.g., FIG. 19, the length of each aperture 72 measured along its route respective aperture axis is greater than its width measured in a direction transverse to that aperture axis. A collector axis 61 extends through the collector 60.

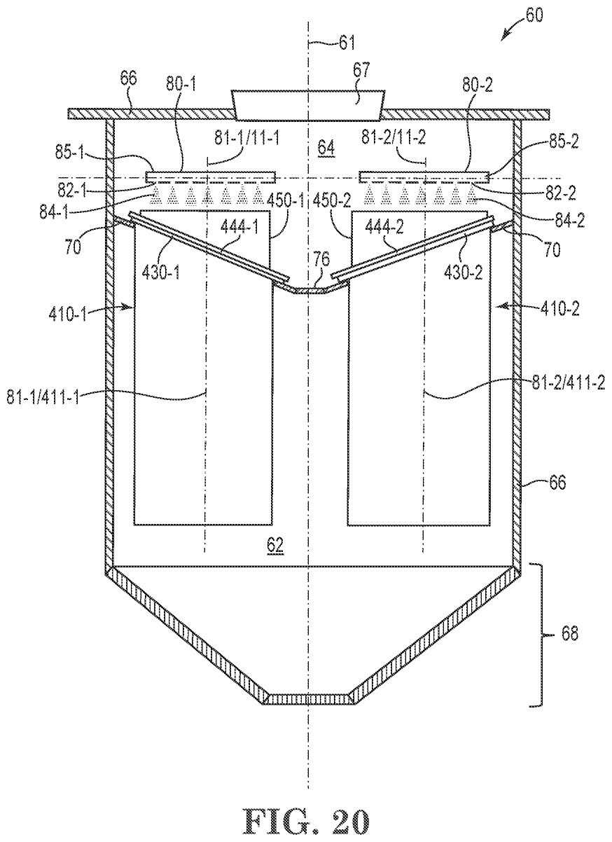

In one or more embodiments, the collector 60 also includes a pulse apparatus located in the clean air volume 64, the pulse apparatus configured to deliver pulsed gas through the apertures 72 in the tubesheet 70. In the illustrative embodiment depicted in FIG. 20, the pulse apparatus is in the form of a pair of jet tubes 85-1 and 85-2. Jet tube 85-1 is positioned proximate aperture 72-1 and configured to deliver pulsed gas through aperture 72-1 while jet tube 85-2 is positioned proximate aperture 72-2 and configured to deliver pulsed gas through aperture 72-2.

Jet tube 85-1 delivers pulsed gas through a series of openings 82-1 with the pulsed gas streams 84-1 exiting the jet tube 85-1 such that the pulsed gas streams 84-1 are directed towards the venturi 450-1 associated with filter 410-1 positioned in aperture 72-1 of collector 60. The pulsed gas streams 84-1 exiting the openings 82-1 in jet tube 85-1 collectively define a central pulse axis 81-1 extending through aperture 72-1. In one or more embodiments, the central pulse axis 81-1 is preferably aligned with the filter axis 411-1 of filter 410-1 located in aperture 72-1 to promote pulse cleaning of the filter 410-1.

Similarly, jet tube 85-2 delivers pulsed gas through a series of openings 82-2 with the pulsed gas streams 84-2 exiting the jet tube 85-2 such that the pulsed gas streams 84-2 are directed towards the venturi 450-2 associated with filter 410-2 positioned in aperture 72-2 of collector 60. Again, the pulsed gas streams 84-2 exiting the openings 82-2 in jet tube 85-2 collectively define a central pulse axis 81-2 extending through aperture 72-2. In one or more embodiments, the central pulse axis 81-2 is preferably aligned with the filter axis 411-2 of filter 410-2 located in aperture 72-2 to promote pulse cleaning of the filter 410-2.

To accommodate filters and filter assemblies having canted openings as described herein, the tubesheet 70 of collector 60 is also angled or canted. The orientation of the portions of the tubesheet 70 containing apertures 72 can be described relative to a reference plane defined by the central pulse axis directed through each of the apertures 72. In the depicted illustrative embodiment of collector 60 in which the central pulse axes 81-1 and 81-2 are aligned with each other, a common reference plane RP1 is defined with reference plane RP1 being oriented transverse to both of the pulse axes 81-1 and 81-2.

With respect to aperture 72-2 in tubesheet 70 through which central pulse axis 81-2 extends, the distance (D) between RP1 and the clean face 76 of the tubesheet 70 surrounding aperture 72-2 changes when moving along the aperture axis 71-2 of aperture 72-2. In the depicted embodiment, that distance increases when moving from right to left, that is, from end 73-2 to end 74-2 of aperture 72-2.

With respect to aperture 72-1 in tubesheet 70 through which central pulse axis 81-1 extends, the distance between RP1 and the clean face 76 of the tubesheet 70 surrounding aperture 72-1 changes when moving along the aperture axis 71-1 of aperture 72-1. In the depicted embodiment, that distance increases when moving from left to right, that is, from end 73-1 to end 74-1 of aperture 72-1.

Another manner in which the orientation of the apertures 72 in the tubesheet 70 of collector 60 may be characterized can be based on the angular relationships between the aperture axes and a reference plane oriented transverse to the central pulse axes passing through the apertures 72. Although reference plane RP1 would provide the same angular relationships, FIG. 18 includes a second reference plane RP2 oriented parallel to reference plane RP1 for clarity in FIG. 18.

With respect to aperture 72-1, the aperture axis 71-1 forms an included angle α-1 (alpha-one) with reference plane RP2 of 5 degrees or more, 10 degrees or more, 15 degrees or more, 20 degrees or more, 25 degrees or more, 30 degrees or more, or 45 degrees or more. At an upper end, included angle α-1 (alpha-one) between the aperture axis 71-1 and the reference plane RP2 is 60 degrees or less, 45 degrees or less, 30 degrees or less, or 20 degrees or less. One range that may be useful could involve included angles α-1 (alpha-one) with reference plane RP2 of 10 degrees to 30 degrees to provide a balance between ease of use and filter size/filtering capacity of the compatible filters.

With respect to aperture 72-2, the aperture axis 71-2 forms an included angle α-2 (alpha-two) with reference plane RP2 of 5 degrees or more, 10 degrees or more, 15 degrees or more, 20 degrees or more, 25 degrees or more, 30 degrees or more, or 45 degrees or more. At an upper end, included angle α-2 (alpha-two) between the aperture axis 71-2 and the reference plane RP2 is 60 degrees or less, 45 degrees or less, 30 degrees or less, or 20 degrees or less. Again, one useful range could involve included angles α-2 (alpha-two) with reference plane RP2 of 10 degrees to 30 degrees to provide a balance between ease of use and filter size/filtering capacity of the compatible filters.

Although the angles formed between the aperture axes and the reference plane are the same, it will be understood that in one or more alternative embodiments of collector's described herein those angles may differ as needed to accommodate different angular relationships between the canted openings of filters used in the collectors described herein.

With reference to FIG. 20 in which a pair of filters 410-1 and 410-2 are, respectively, located in apertures 72-1 and 72-2 in tubesheet 70 within collector 60, it can be seen that the filter seals 430-1 and 430-2 of the filters 410-1 and 410-2 form a seal with the clean face 76 of the tubesheet 70 surrounding each of the apertures.

In the depicted embodiment, the filters 410-1 and 410-2 also include seal supports 444-1 and 444-2 attached to venturis 450-1 and 450-2. Though seal supports may be used to at least partially compress the filter seals 430-1 and 430-2 to form a suitable seal to prevent the unwanted passage of air or other gases and/or particulate matter between the interface between the filter seals 430-1 and 430-2 and the tubesheet 70 as needed to promote proper filtering of particulate matter from the air or other gases in which it is delivered to the dirty air volume 62 of collector 60.

As discussed herein and depicted in FIG. 20, the central pulse axes 81-1 and 81-2 passing through each aperture 72-1 and 72-2 of the tubesheet 70 is aligned with the filter axes 411-1 and 411-2 of each of the filters 410-1 and 410-2 located within the apertures 72-1 and 72-2.

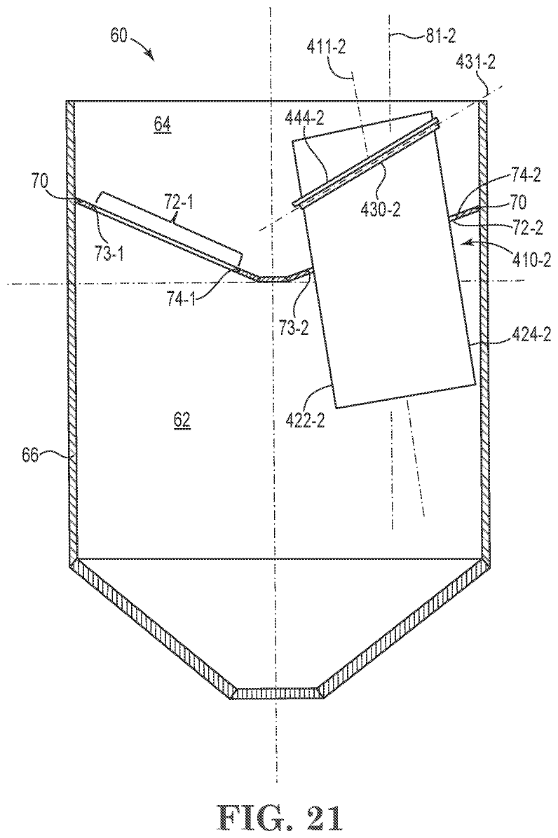

FIG. 21 (which is a simplified version of the collector 60 as depicted in FIG. 20) provides an illustration depicting one advantage of the enlarged openings provided by the angled or canted filter seals and filter openings of filters as described herein when placing or removing a filter from an aperture in a tubesheet. As depicted in FIG. 21, it may be beneficial or even required to remove pulse apparatus located in the clean air volume 64 of the collector 60 during insertion and/or removal of filters.

Filter 410-2 depicted in FIG. 21 includes a filter seal 430-2 that extends along a seal axis 431-2 oriented at a non-perpendicular angle with the filter axis 411-2 as discussed above in connection with, for example, filters 10 and 110. As a result, a height of the filter as measured between edges 422-2 and 424-2 in a direction transverse to the filter axis 411-2 is less than a length of the filter seal 430-2 measured along seal axis 431-2. That enlarged seal 430-2 allows for a larger aperture 72-2 in tubesheet 70, with the larger aperture 72-2 having a length between first end 73-2 and a second end 74-2 that is greater than the height of the filter as measured between edges 422-2 and 424-2.

In other words, the aperture 72-2 into which the filter 410-2 is inserted is larger than the filter 410-2 to a degree that makes passage of the filter 410-2 through aperture 72-2 easier. It is, of course, understood that any aperture through which a filter is to be inserted would be at least as large as the filter in any conventional collector. However, the enlarged filter opening provided by the angled or canted filter seal and corresponding filter opening provides even greater clearance between the edges of the filter and the aperture through which the filter passes during insertion and removal.

Movement of the filter 410-2 through aperture 72-2 in a direction that is not aligned with the central pulse axes 81-2 provides an operator with the ability to take advantage of the larger aperture 72-2 as compared to the smaller filter 410-2 when inserting and/or removing a filter from the aperture 72-2.

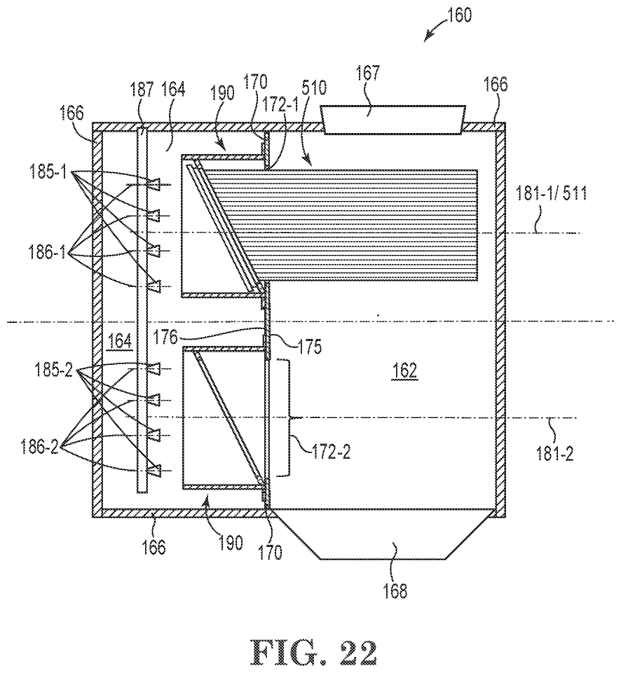

One alternative illustrative embodiment of a collector 160 is depicted in FIG. 22. The collector 160 includes a tubesheet 170 located in a housing defined by walls 166 to define a dirty air volume 162 and a clean air volume 164 with clean air outlet 167 providing a path for clean air to exit the clean air volume 164. Although not depicted, a dirty air inlet delivers dirty air to the dirty air volume 162. Collector 160 also includes a hopper 168 into which particulate matter moves after dislodgment from filters located in the dirty air volume 162.

Tubesheet 170 may be described as having a dirty face 175 facing the dirty air volume 162 and a clean face 176 facing the clean air volume 164 within the collector 60. The depicted tubesheet includes apertures 172-1 and 172-2 formed through the tubesheet 170 Collector 160 also includes a pulse apparatus in the form of two sets of nozzles 185-1 and 185-2. In particular, nozzles 185-1 are aligned with aperture 172-1 while nozzles 185-2 are aligned with aperture 172-2. Each of the nozzles 185-1 defines a nozzle axis 186-1 along which pulsed gas (e.g., air) is directed when exiting the nozzles 185-1. The pulsed gas is provided from a plenum 187 to which the nozzles 185-1 are fluidly connected. The nozzle axes 186-1 collectively define a central pulse axis 181-1 that extends through aperture 172-1.

Nozzles 185-2 aligned with aperture 172-2 and define nozzle axes 186-2 along which pulsed gas (e.g., air) is directed when exiting the nozzles 185-2. The pulsed gas is also provided from plenum 187 to which the nozzles 185-2 are fluidly connected. The nozzle axes 186-2 collectively define a central pulse axis 181-2 that extends through aperture 172-2.

A filter 510 is positioned within aperture 172-1 in FIG. 17 to illustrate that the central pulse axis 181-1 is preferably aligned with a filter axis DXI extending through filter 510 as discussed in connection with various embodiments of filters described herein.

While tubesheet 170 and the apertures 172-1 and 172-2 formed therein have a generally planar configuration, the collector 160 includes a set of tubesheet adapters used to accommodate filters and filter assemblies having canted openings as described herein. In particular, collector 160 includes one illustrative embodiment of an adapter 190 positioned within the clean air volume 164 over aperture 172-1 and another adapter 190 positioned within the clean air volume 164 over aperture 172-2.

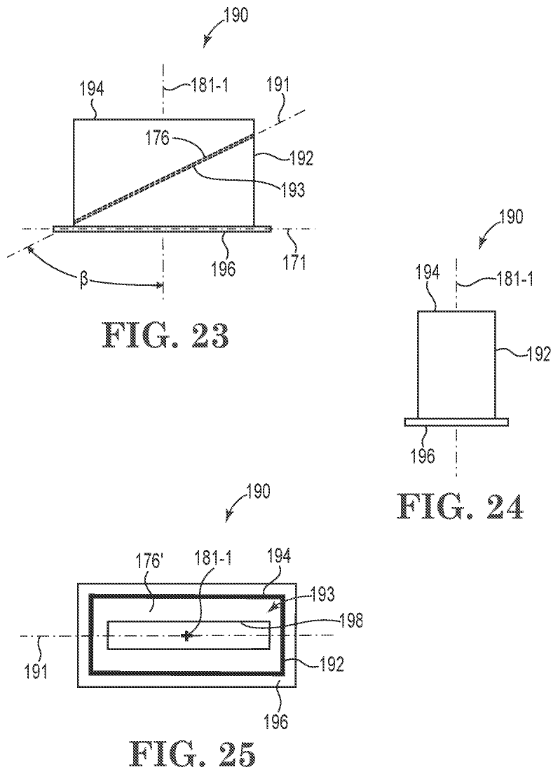

FIGS. 23-25 depict various views the adapter 190 removed from the collector 160. The depicted adapter 190 includes a sleeve 192 extending between a base opening provided in base 196 and a receiving opening 194. The base 196 of the adapter 190 is configured to seal against the clean face of a tubesheet (e.g., clean face 176 of tubesheet 170) when the adapter 190 is properly positioned in a collector.

A platform 193 is located within sleeve 192, with the platform 193 comprising a platform aperture 198 configured to receive a filter in the same manner as discussed with respect to tubesheet apertures described herein. In essence, platform 193 defines, within the bounds of the sleeve 192, an effective clean face 176′ of a tubesheet (e.g., tubesheet 170) on which the adapter 190 is positioned, with the effective clean face 176′ being removed or spaced apart from the planar tubesheet on which the adapter 190 is positioned.

As depicted in FIG. 23, the platform 193 (depicted in broken lines because it is hidden from view by the sleeve 192) is preferably oriented at an angle relative to a central pulse axis (e.g., central pulse axis 181-1 depicted in each of FIGS. 23-25) that is similar to the angles described herein for tubesheets having canted or angled faces configured to receive filters having canted or angled openings as described herein. In one or more embodiments, the included angle β (beta) depicted in FIG. 23 between a platform axis 191 extending between opposing ends of the platform aperture 198 formed in platform 193 and a reference plane 171 defined by a tubesheet on which the adapter 190 is located (and which is typically transverse to a central pulse axis 181-1 extending through the platform aperture 198) of less than 90 degrees, 85 degrees or less, 80 degrees or less, 75 degrees or less, 70 degrees or less, 65 degrees or less, 60 degrees or less, or 45 degrees or less. At a lower end, the included angle β (beta) may, in one or more embodiments, be 45 degrees or more, 60 degrees or more, 65 degrees or more, 70 degrees or more, or 75 degrees or more. One range that may be useful for angle β (beta) is 60 degrees to 80 degrees to match the angles of complementary filters that provide a balance between ease of use and filter size/filtering capacity.

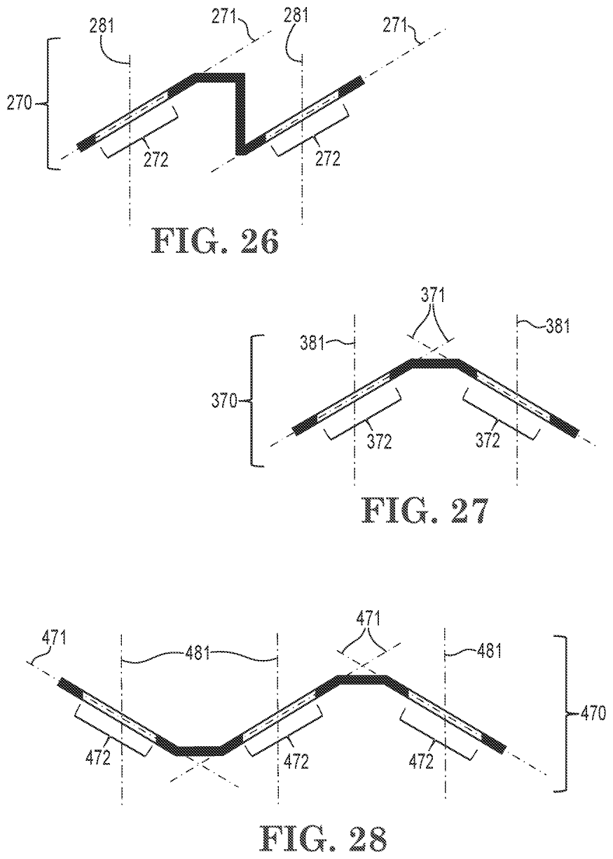

FIGS. 26-28 are provided to illustrate (schematically) only a few of the many different potential tubesheets that may be provided in collectors as described herein.

In FIG. 26, the tubesheet 270 may be described as a sawtooth pattern in which apertures 272 are oriented along aperture axes 271 such that the aperture axes 271 form similar angles with a set of aligned pulse axes 281 extending through the apertures 272 in tubesheet 270.

In FIG. 27, tubesheet 370 may be described as having a convex shape in which apertures 372 are oriented along aperture axes 371 such that the aperture axes intersect with each other above tubesheet 370 and form equal but opposite angles with the pulse axes 381 extending through the apertures 372.

In FIG. 28, tubesheet 470 may be described as having both a convex and concave shape. In particular, the tubesheet 470 containing the pair of apertures on the left side of tubesheet 470 form a concave shape in which apertures 472 are oriented along aperture axes 471 (similar to, for example, apertures 72 in tubesheet 70 as depicted in FIGS. 13-16), while the portion of the tubesheet 470 containing the pair of apertures 472 on the right side of tubesheet 470 form a convex shape similar to that depicted in FIG. 27.

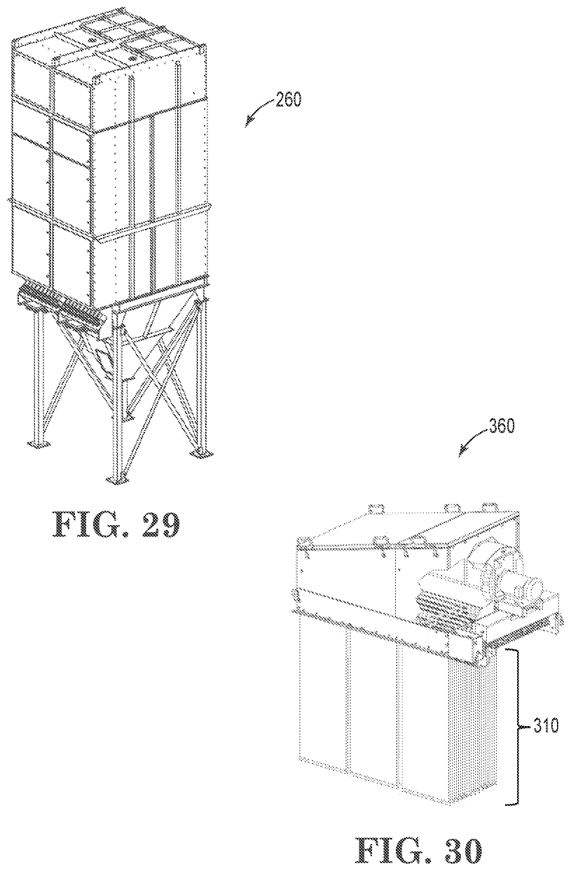

FIG. 29 depicts one illustrative embodiment of a collector 260 that may be commonly referred to as a cased collector in which both the clean air volume and dirty air volumes are defined by the housing of the collector. In particular, the housing defines a dirty air volume bounded in part by the dirty face of the tubesheet in the collector such that the collector comprises an encased collector in which filter bodies of filters located in the collector are located in the dirty air volume.

FIG. 30 depicts one illustrative embodiment of an insertable collector 360 in which the tubesheet and housing combine to define the clean air volume while filters 310 are positioned within a dirty air volume that is defined only after the insertable collector 360 is attached to an otherwise enclosed structure (such as a bin, silo, etc.). In such insertable collectors, the housing does not define a dirty air volume until the collector is attached to the otherwise enclosed structure (such as a bin, silo, etc.).

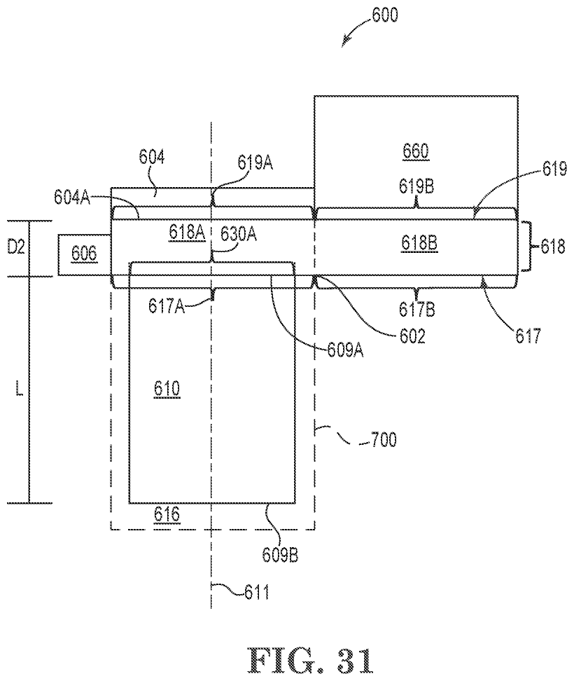

With reference to the figures of the drawing, wherein like reference numerals designate like parts and assemblies throughout the several views, FIGS. 31-36 depict various features that may be used in one or more embodiments of collectors as described herein to remove particulate matter from a gas stream (e.g., air) in which particulate matter is entrained. The collectors may be particularly adapted to use filters having canted or angled openings as described herein (where those filters may or may not be provided along with a filter support as described herein). In one or more embodiments, the collectors may include a filter 10 as described herein. In one or more embodiments, the collectors may further include part or all of various embodiments of any filter assembly as described herein, any collector 60 as described herein, and any filter support 40 as described herein.

One illustrative embodiment is depicted in FIG. 31, which illustrates a schematic of a collector 600. The depicted collector 600 includes a housing 602 including a first panel 617 (which functions as, e.g., a tubesheet) and a second panel 619, a clean air chamber 618 (e.g., including 618 A and 618B), an access cover 604, a manifold 606, a filter 610, and a fan enclosure 660. The collector 600 may optionally further include a filter housing 700 surrounding the filter 610 to define a dirty air chamber 616 containing the filter 610 (if the collector 600 is provided as, e.g., a “cased collector”). A filter axis, 611, is shown which extends through the access cover 604, a clean air chamber first portion 618A of the clean air chamber, and the filter 610.

In use, dirty air is delivered to the filter 610 which traps or collects particulate matter in the dirty air. Clean air passes through the filter 610 to enter the clean air chamber 618. Then, clean air may exhaust out into an ambient environment (not shown). Optionally, a fan (not shown) located within the fan enclosure 660 may pull air through the collector 600 as described herein. Over time, particulate and other matter accumulates on the outside of the filter 610 and/or within the dirty air chamber 616. Reverse pulses of air may be delivered into the filter 610 to shake loose or dislodge any particulate on the outside of the filter 610. Pulses may, in one or more embodiments, be delivered using a jet tube (not shown) located within the clean air chamber 618, and compressed gas (e.g., air) may be supplied from and using the manifold 606.

The housing 602 defines the clean air chamber 618 of the depicted illustrative embodiment between the first panel 617 (e.g., 617A, 617B) and the second panel 619 (e.g., 619A, 619B). The first panel 617 may include a tubesheet section 617A and a housing section 617B. The second panel 619 may include an access section 619A and an exhaust section 619B. The first and second panels 617, 619 may advantageously provide structure to or be a part of the housing 602. The housing 602 (and associated panels) may be constructed using one or more of a metal, a plastic, a composite, a ceramic, or any other suitable material or combination of materials.

The depicted illustrative embodiment of collector 600 includes a filter aperture 630A located in the tubesheet section 617A. The filter aperture 630A is preferably sized to retain an open end of the filter 610, as described further herein. The tubesheet section 617A may, in one or more embodiments, include a mount to releasably secure the filter 610 in the filter aperture 630A. In proper operation, unfiltered air cannot pass into the clean air chamber 618 without first passing into/through the filter 610 and then through the filter aperture 630A in the tubesheet section 617A.

Some specific filters are described further herein, but it is to be understood that a variety of filters, with a variety of materials and sizes, can be used with one or more embodiments of the collectors described herein. The illustrative embodiments of the filter 610 may, in one or more embodiments, include flanges or other features at a proximal end 609A that may facilitate attachment between the filter 610 and filter aperture 630A in the tubesheet section 617A in manners that limit or prevent leakage through those junctions. The proximal end 609A is the end of the filter 610 proximate the filter aperture 630A and opposite the distal end 609B of the filter 610. In one or more embodiments, for example, the filters 610 may take any suitable form, e.g., bags, socks, cartridges, etc.

The depicted illustrative embodiment of collector 600 includes an access aperture 604A located in the access section 619A of the second panel 619. The access aperture 604A may be sized, for example, to provide access to the interior of the housing 602 by an operator or user. The access aperture 604A may advantageously provide access to the interior of the housing 602 to allow for removal and replacement of filter 610 in filter aperture 630A. The access cover 604 closes the access aperture 604A. In one or more embodiments, the access cover 604 may take any suitable form capable of closing the access aperture 604A for proper operation of the collector, e.g., a hinged door which may be opened and closed by the operator or user, a removable panel, roll-away panel, etc.

The clean air chamber first portion 618A is, in the depicted embodiment, located between the tubesheet section 617A of first panel 617 and the access section 619A of second panel 619. The clean air chamber first portion 618A defines a first clean air portion volume. The depicted collector 600 further includes a clean air chamber second portion 618B. The clean air chamber second portion 618B is, in the depicted embodiment, also located between the first panel 617 and the second panel 619.

The filter 610 is, in one or more embodiments, positioned in a filter aperture 630A in the tubesheet section 617A of the first panel 617 as described herein. In one or more embodiments, clean air entering the clean air chamber first portion 618A through the filter aperture 630A must pass through the filter 610 before passing through a filter aperture 630A in the tubesheet section 617A to enter the clean air chamber. The depicted filter 610 includes a distal end 609B located distal from the filter aperture. The filter axis 11, extends through the filter aperture 630A and the distal end 609B. The filter axis 11 also passes through the clean air chamber first portion 618A, and the access aperture 604A in the access section 619A. In one or more embodiments, the position of the filter axis 11 within the filter aperture 630A may be described as being located in the geometric center of a projection of the filter aperture 630A on a plane oriented orthogonal to the filter axis 11.

In one or more embodiments such as the depicted illustrative embodiment, the filter axis 11 does not extend through the clean air chamber second portion 618B. In such embodiments, the clean air chamber second portion 618B can be described as being offset from the clean air chamber first portion 618A in a direction transverse to the filter axis 11. That offset may, in one or more embodiments, provide the opportunity to offer a collector including a clean air chamber having a reduced or controlled depth to facilitate removal and replacement of filters as described herein. Various offset distances may be contemplated in the present disclosure, including various clean air chamber volumes and shapes.

In one or more embodiments (and as shown in the illustrative embodiment depicted in FIGS. 31-36), the collector 600 may be oriented such that the filter axis 11 is vertical (i.e., aligned with the direction of gravity). In alternative embodiments, the collector 600 may be oriented such that filter axis 11 forms any suitable angle relative to the direction of gravity. In some alternative orientations, the outer edge of the manifold 606 or the outer edge of the fan enclosure 660 (outer edge may be defined as the edge of the element that is distal to the filter axis 11) may be at the bottom, or base, of the collector.

The ability to place the collector 600 such that that filter axis 11 is oriented at any suitable angle relative to the direction of gravity allows for the collector 600 to be installed in a variety of orientations as needed to fit a specific site and/or to improve one or more selected benefits (e.g., filter removal/replacement, space-saving, efficient filtration, etc.) of a specific embodiment.

The clean air chamber second portion 618B is, in the depicted illustrative embodiment, adjacent the clean air chamber first portion 618A. Such an arrangement may advantageously provide more surface area to the housing 602 for additional elements (e.g., the access cover 604, the manifold 606, and the fan enclosure 660), and thus may, in one or more embodiments, allow for various configurations of components of the collectors described herein. In embodiments without a fan 612, the fan enclosure 660 may be smaller. These factors may also advantageously allow for the collector 600 to be installed in a variety of orientations as needed to fit a specific site or to improve one or more selected benefits (e.g., filter removal/replacement, collector size, etc.) of a specific implementation.

In one or more embodiments of cased collector as described herein, a filter housing 700 may be coupled to the tubesheet section 617A. The filter housing 700 may surround the filter 610 to define a dirty air chamber. Collectors that do not include a filter housing 700 defining a dirty air chamber may be referred to as “insertable” collectors in which the filters 610 are “inserted” into a volume from which particulate matter and air are to be removed. Collectors that include the optional filter housing 700 defining a dirty air chamber typically include a dirty air inlet configured to deliver dirty air (e.g., air containing particulate matter to be removed from the air) into the dirty air chamber defined by the housing 700. Such systems are well known and their features will not be further described herein.

The filters 610 in collectors as described herein may be described as defining a filter length, L, along the filter axis 11 between and including the distal end 609B of the filter 610 and the filter aperture 630A in tubesheet section 617A.

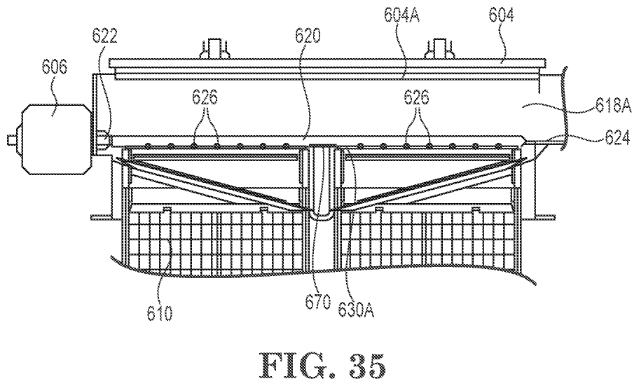

In the depicted illustrative embodiment, the clean air chamber first portion 618A defines a first portion depth, D2, measured along the filter axis 11 between and including the filter aperture 630A in the tubesheet section 617A of first panel 617 and the access aperture 604A in the access section 619A of second panel 619. In one or more embodiments, the first portion depth D2 may be equal to or less than half of the filter length L. This relationship may advantageously reduce the volume of the collectors, and may further advantageously allow for more efficient cleaning, maintenance, servicing, and/or replacing of filters and/or jet tubes (see, e.g., FIG. 35 and related descriptions). At an upper end, the first portion depth D2 may, in one or more embodiments, be equal to or less than 20%, 30%, 40%, or 50% of the filter length L. At a lower end, the first portion depth D2 may, in one or more embodiments, be equal to or greater than 10%, 20%, 30%, or 40% of the filter length L.

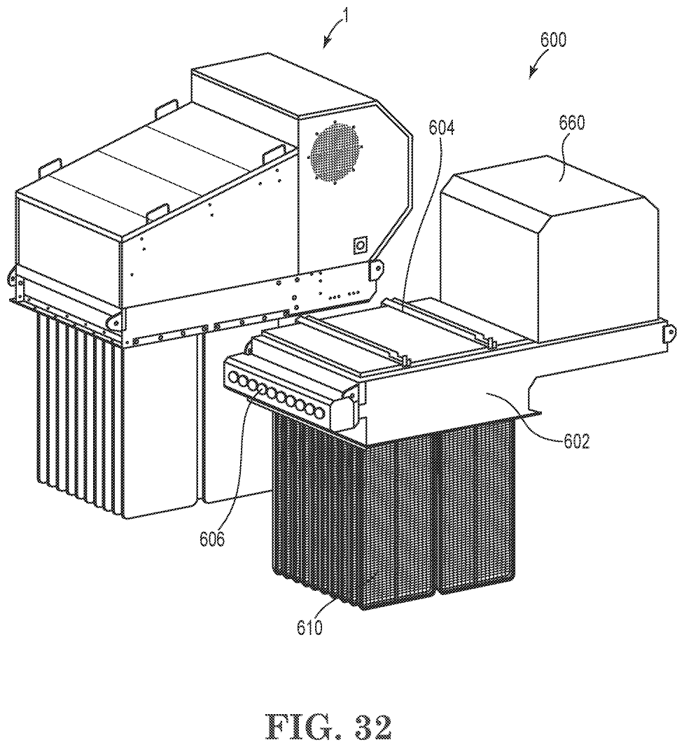

FIG. 32 illustrates both a prior collector 1 (Donaldson Company Dalamatic Insertable “DLMV” filtration system, as described at least in DALAMATIC Dust Collectors, Donaldson TORIT brochure, donaldsontorit.com, accessed on February 24, 2023) and one illustrative embodiment of a collector 600 as described herein. As illustrated, the prior art collector 1 includes a similar structure, but with a deeper clean air chamber through which the filters must pass when being removed or inserted.

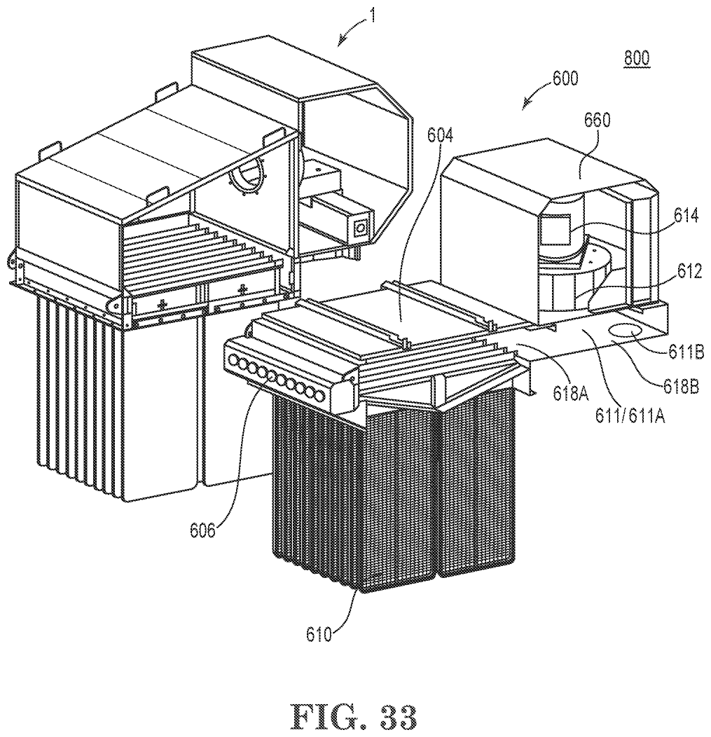

FIG. 33 depicts the collectors of FIG. 32 with one or more portions of the housings removed to expose some of the internal components of the collectors of FIG. 32. As seen in FIG. 33, the depicted embodiment of collector 600 includes a clean air outlet 611 in in fluid communication with the clean air chamber second portion 618B. Clean air entering the clean air chamber first portion 618A passes into the clean air chamber second portion 618B before leaving the clean air chamber 618. The clean air outlet 611 may be located in the exhaust section 619B. The exhaust section 619B may be located adjacent the access section 619A.

For purposes of this disclosure, the tubesheet section 617A may be a tubesheet 670 as described further herein (instead of, e.g., an impermeable wall of the housing 602). In embodiments where the tubesheet section 617A is a tubesheet 670, the tubesheet 670 still separates an interior volume of the housing 602 and associate clean air chamber 618 from the filter 610 and optional dirty air chamber 616. The tubesheet 670 may be described as having a dirty air side facing the dirty air chamber 616 and a clean air side facing the clean air chamber 618. In embodiments where the tubesheet section 617A is a tubesheet 670, the tubesheet 670 includes filter apertures 630A in and/or over which the filters 610 are positioned are seen in FIGS. 31 and 33.

In one or more embodiments, the filter aperture 630A may include a first filter aperture 630A of a plurality of filter apertures 630A located in the tubesheet section 617A, as illustrated in FIG. 33. The filter 610 may include a first filter 610 of a plurality of filters 610 positioned in the plurality of filter apertures 630A. The filter axis 11 may include a first filter axis 11 of a plurality of filter axes 11 extending through the plurality of filter apertures 630A. The plurality of filter axes 11 may pass through the clean air chamber first portion 618A and the access section 619A.

Also depicted in the illustrative embodiment of FIG. 33 are a fan 612 and a motor 614. The fan enclosure 660 may be coupled to the housing 602 proximate the exhaust section 619B. The fan enclosure 660 may include a fan air inlet 611A fluidically coupled to the clean air outlet 611. The fan enclosure 660 may include a fan air outlet 611B. The fan air outlet 611B is fluidically coupled to an ambient environment 800. In embodiments where the collector 600 is mounted vertically such that the filter axis 11 is vertical with respect to the ground, the fan air outlet 611B may be protected from the weather and/or ambient elements because it faces the ground. In further embodiments where the collector 600 is not mounted vertically, the fan air outlet 611B may be protected from the weather and/or ambient elements via a grate or other air-permeable covering. The fan enclosure 660 may include the fan 612 mounted within the fan enclosure 660. The fan 612 may be mounted proximal to the fan air inlet 611A. In alternative embodiments, the fan 612 may be mounted distal to the fan air inlet 611A. In further alternative embodiments, the fan 612 may be offset from the closest filter axis 11 by a selected distance. In further alternative embodiments, there may not be a fan 612 and the fan enclosure 660 may be smaller.

The fan enclosure 660 may further include the motor 614. The motor 614 may be coupled to the fan 612. The motor 614 may be configured to power the fan 612 to draw air from the clean air outlet 611 towards the ambient environment 800. The fan 612 may advantageously pull unfiltered air into the collector 600 and push filtered air out of the collector 600, and may increase the efficiency and/or speed of the collector 600. The motor may include any electrical, gas, or battery-operated fan 612 sized to fit the collector 600.

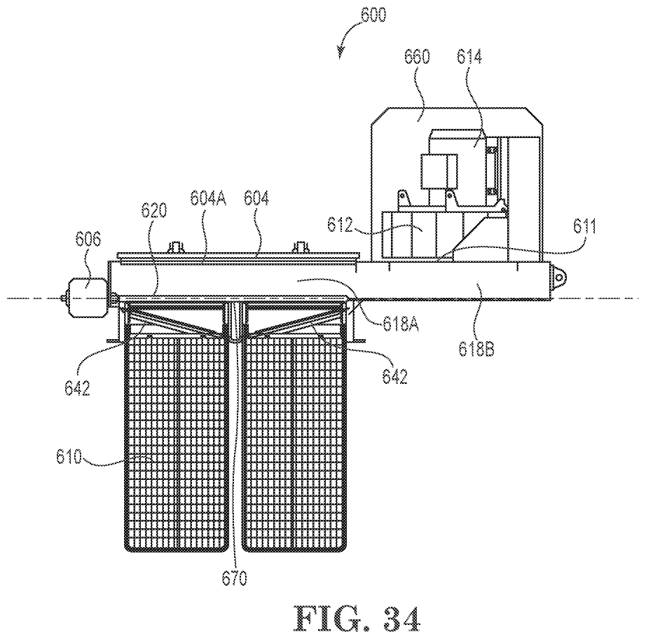

FIG. 34 is a side view of the illustrative embodiment of collectors described herein and depicted in FIGS. 32-33. The depicted collector 600 also includes a jet tube 620 as part of a pulse-jet cleaning system. The pulse-jet cleaning system may include, e.g., the jet tube 620, the manifold 606, etc. The jet tube 620 is configured to direct a pulse of air into the filter 610 as described herein. The collector 600 may also include an optional hopper (e.g., FIG. 7 reference numeral 568) to collect particulate matter shaken off of the filter 610 as described herein.

The jet tube 620 may extend along a jet tube axis, J. The jet tube 620 transfers gas (e.g., air) from an ambient environment (e.g., ambient environment 800, FIG. 33) to an outlet (e.g., lateral opening 626, FIG. 35). The jet tube 620 may be tubular or may be any other shape. The jet tube 620 may extend along the jet tube axis J within the clean air chamber 618. The jet tube axis J may be substantially parallel to a surface area of the first panel 617. This may advantageously allow for more targeted air pulses into the filters 610, which may remove particulate more efficiently. However, in alternative embodiments, the jet tube axis J may not be substantially parallel to the surface area of the first panel 617. This may advantageously allow for the filters 610 to be mounted to the housing 602 at an angle, so that the air pulses are still directly pulsed into the filters 610 along the filter axis 11, but the filter axis 11 may be slightly tilted while remaining within the scope of this disclosure.

Also seen in FIG. 34 are optional support cages 642 that may, in one or more embodiments, be attached to the tubesheet 670. The support cages 642 are described herein with respect to further embodiments as reference number 42, and may be provided to assist in supporting the filters 610.

FIG. 35 is an enlarged partial side view of the collector of FIG. 34. The jet tube 620 depicted in connection with the illustrative embodiment of filtration collector 600 is configured to direct air into the filters 610 through the filter apertures 630A in the tubesheet 670. The air from the jet tube 620 enters the filters 610 to remove particulate matter from the filters 610 in a manner similar to that described in, e.g., U.S. Pat. No. 4,218,227 (Frey), U.S. Pat. No. 5,562,746 (Raether), U.S. Pat. No. 6,090,173 (Johnson et al.), U.S. Pat. No. 6,902,592 (Green et al.), U.S. Pat. No. 7,641,708 (Kosmider et al.), and U.S. Pat. No. 8,075,648 (Raether).

More specifically, the jet tube 620 may include a lateral opening 626. The lateral opening 626 may open towards the filter aperture 630A. The jet tube 620 may include a first jet tube 620 of a plurality of jet tubes 620 positioned within the clean air chamber 618. The lateral opening 626 may include a first lateral opening 626 of a plurality of lateral openings 626 positioned on the plurality of jet tubes 620.

The plurality of lateral openings 626 may be positioned on a single jet tube 620. The plurality of lateral openings 626 may be positioned across various jet tubes 620 of the plurality of jet tubes 620. A single jet tube 620 may have one or more lateral openings 626. The lateral openings 626 may vary in size, shape, and distribution along a jet tube 620 or the plurality of jet tubes 620. The jet tube 620 may be provided as part of a pulse-jet cleaning system including one or more sources of pressurized gas (e.g., air), valves and a control system. The pulse-jet cleaning system may include, for example, the manifold 606. The manifold 606 may be configured to provide compressed air to the jet tube 620 or plurality of jet tubes 620.

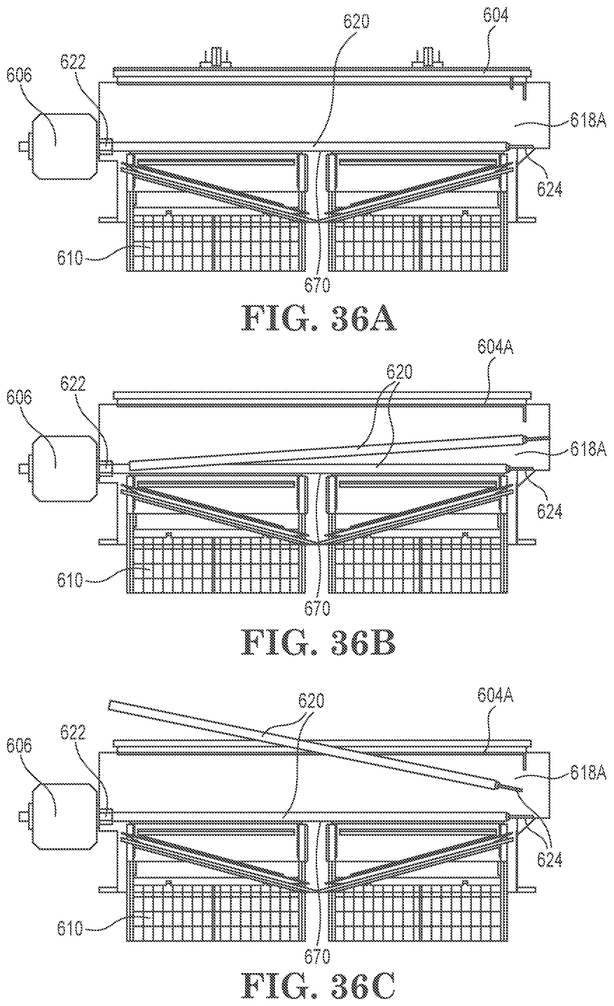

FIGS. 36A-36C depict various stages of removal and/or reinsertion of a jet tube 620 into the housing 602. A method of servicing the jet tube 620 of the collector 600 may include, in no particular order: opening the access cover 604 (FIG. 36A), lifting the jet tube 620 towards the open access cover 604 (FIG. 36B), disconnecting the jet tube 620 from the housing 602, removing the jet tube 620 from the collector 600 (FIG. 36C), disposing of the jet tube 620, inserting a different jet tube 620 into the collector 600 (FIG. 36C), connecting the different jet tube 620 to the housing 602 (FIG. 36B), and closing the access cover 604 (FIG. 36A). To disconnect the jet tube 620 from the housing 602, the jet tube 620 may be removed from a connector piece 622. To remove the jet tube 620 from the collector 600, a user may allow a distal end 624 to remain in the housing, lift a proximal end opposite the distal end 624 out of the access aperture 604A, and then remove the distal end 624. To insert a jet tube 620, the reverse may be true.

A similar method may be used to remove and/or reinsert a filter 610 into the housing 602. A method of servicing the filter 610 of the collector 600 may include, in no particular order: opening the access cover 604 (FIG. 36A), moving the filter 610 towards the access aperture 604A such that the body of the filter 610 passes through the filter aperture 630A in the tubesheet section 617A to remove the filter 610 from the collector 600 (not shown), inserting a different filter 610 into the collector 600 (not shown), and closing the access cover 604 (FIG. 36A).

Replacing, removing, reinserting, and/or servicing the jet tube 620, the filter 610, or any other internal components of the collector 600 may be facilitated by the reduced depth of the clean air chamber as described herein. More specifically, in one or more embodiments of the collectors described herein, when the first portion depth D2 is, for example, equal to or less than half of the filter length L, a user may more easily reach into the collectors and grasp the filters to remove/replace them.

### Illustrative Aspects

Following are some illustrative aspects of the filters, filter assemblies, collectors, and methods described herein.

In independent aspect A1, a filter as described herein includes a filter body attached to a filter seal, wherein the filter body comprises an envelope-shaped filter body that comprises filter media defining an interior volume within the filter, the filter body comprising an open end and a closed end, the filter body extending along a filter axis that extends between the open end and the closed end of the filter body, the filter body defining a first major side and a second major side, wherein the first major side and the second major side are defined by the closed end and the open end of the filter body when moving along the filter axis and wherein the first major side and the second major side are further defined by a first edge and a second edge when moving along the filter axis between the open end and the closed end, the first edge and the second edge extending from the closed end to the open end of the filter body, wherein the filter body comprises pleated filter media comprising pleats extending along the filter body from the filter seal to the closed end or a plurality of filter tubes; wherein the filter seal is positioned around a perimeter of the open end of the filter body and configured to form a seal with a seal surface when the filter is installed in an aperture of a tubesheet such that gas passing into the interior volume must pass through the filter media or through the filter opening;
and wherein the first edge of the filter body is shorter than the second edge of the filter body.

In aspect A2 according to aspect A1, the filter seal comprises an elongate shape comprising a seal length measured along a seal axis extending between a first end of the filter seal proximate the first edge of the filter body and a second end of the filter seal proximate the second edge of the filter body, wherein the seal length is greater than a filter body height measured between the first edge and the second edge along the filter height axis.

In aspect A3 according to any one of aspects A1 to A2, a length of the first edge of the filter body between the closed end and the filter seal is greater than a height of the filter body measured between the first edge and the second edge along the filter height axis.

In aspect A4 according to any one of aspects A2 to A3, the seal axis forms an included angle with the filter axis of less than 90 degrees, 85 degrees or less, 80 degrees or less, 75 degrees or less, 70 degrees or less, 65 degrees or less, 60 degrees or less, or 45 degrees or less.

In aspect A5, a filter as described herein includes a filter body attached to a filter seal, wherein the filter body comprises an envelope-shaped filter body that comprises filter media defining an interior volume within the filter, the filter body comprising an open end and a closed end, the filter body extending along a filter axis that extends between the open end and the closed end of the filter body, the filter body defining a first major side and a second major side, wherein the first major side and the second major side are defined by the closed end and the open end of the filter body when moving along the filter axis and wherein the first major side and the second major side are further defined by a first edge and a second edge when moving along the filter axis between the open end and the closed end, the first edge and the second edge extending from the closed end to the open end of the filter body, wherein the filter body comprises pleated filter media comprising pleats extending along the filter body from the filter seal to the closed end or a plurality of filter tubes; wherein the filter seal is positioned around a perimeter of the open end of the filter body and configured to form a seal with a seal surface when the filter is installed in an aperture of a tubesheet such that gas passing into the interior volume must pass through the filter media or through the filter opening; wherein the filter seal comprises an elongate shape comprising a seal length measured along a seal axis extending between a first end of the filter seal proximate the first edge of the filter body and a second end of the filter seal proximate the second edge of the filter body, wherein the seal length is greater than a filter body height measured between the first edge and the second edge along the filter height axis; and wherein the seal axis forms an included angle with the filter axis of less than 90 degrees, 85 degrees or less, 80 degrees or less, 75 degrees or less, 70 degrees or less, 65 degrees or less, 60 degrees or less, or 45 degrees or less.

In aspect A6 according to any one of aspects A4 to A5, the included angle between the seal axis and the filter axis is 45 degrees or more, 60 degrees or more, 65 degrees or more, 70 degrees or more, or 75 degrees or more.

In aspect A7 according to any one of aspects A1 to A6, the closed end of the filter extends along a closed end axis that is transverse to the filter axis and aligned with the filter height axis.

In aspect A8 according to any one of aspects A1 to A7, the filter body comprises a filter body height measured between the first edge and the second edge along the filter height axis, and wherein the filter body comprises a filter body width measured between the first major side and the second major side of the filter body in a direction that is transverse to both the filter axis and the filter height axis, wherein the filter body width is 0.25 or less, 0.2 or less, or 0.1 or less times the filter body height.

In aspect A9 according to any one of aspects A1 to A8, the filter body comprises pleated filter media comprising pleats extending along the filter body from the filter seal to the closed end.

In independent aspect B1, a filter assembly as described herein includes: a filter comprising a filter body attached to a filter seal, the filter body comprising an envelope-shaped filter body that comprises filter media defining an interior volume within the filter, the filter body comprising an open end and a closed end, the filter body extending along a filter axis that extends between the open end and the closed end of the filter body, the filter body defining a first major side and a second major side, wherein the first major side and the second major side are defined by the closed end and the open end of the filter body when moving along the filter axis and wherein the first major side and the second major side are further defined by a first edge and a second edge when moving along a filter height axis oriented transverse to the filter axis, the first edge and the second edge extending from the closed end to the open end of the filter body, wherein the filter seal is positioned around a perimeter of the open end of the filter body and configured to form a seal with a seal surface when the filter is installed in an aperture of a tubesheet such that gas passing into the interior volume must pass through the filter media or through the filter opening; and a filter support comprising a seal support attached to a support cage, the support cage extending away from the seal support along a cage axis aligned with the filter axis when the support cage is located in the interior volume of the filter and the filter seal is in contact with the seal support, wherein the support cage is configured for placement within the interior volume of the filter, the support cage comprising a distal end proximate the closed end of the filter body when the filter seal is in contact with the seal support, wherein, when the support cage is located in the interior volume of the filter, the support cage comprises a first strut located proximate the first edge of the filter body and a second strut located proximate the second edge of the filter body, wherein the first strut extends from the seal support to a distal end proximate the closed end of the filter and the second strut extends from the seal support to a distal end proximate the closed end of the filter, and wherein the seal support comprises a support aperture aligned with the filter opening when the support cage is located within the interior volume of the filter and the filter seal is configured to form a seal with a filter side of the seal support such that gas passing into the interior volume through the filter opening passes through the support aperture of the seal support.

In aspect B2 according to aspect B1, the filter support comprises a venturi attached to the filter support, wherein gas passing into the interior volume through the filter opening passes through the venturi before passing into the interior volume of the filter when the support cage is located in the interior volume of the filter.

In aspect B3 according to aspect B2, the venturi extends between a collector opening facing away from the support cage and a filter opening facing the support cage, wherein the collector opening comprises an elongated collector opening extending from a first end to a second end along a venturi axis, wherein the venturi comprises a first depth proximate the first end that is greater than a second depth proximate the second end, wherein the first depth is measured between the first end of the collector opening and the seal support in a direction along the cage axis and the second depth is measured between the second end of the collector opening and the seal support in a direction aligned with the cage axis.

In aspect B4 according to any one of aspects B2 to B3, the support aperture of the seal support comprises an elongate shape comprising an aperture length measured along an aperture axis extending between a first end of the support aperture proximate a junction between the first strut and the seal support and a second end of the support aperture proximate a junction between the second strut and the seal support, wherein the venturi axis forms an included angle with the aperture axis of 5 degrees or more, 10 degrees or more, 15 degrees or more, 30 degrees or more, or 45 degrees or more, and optionally, wherein the included angle between the venturi axis and the aperture axis is 60 degrees or less, 45 degrees or less, or 30 degrees or less.

In aspect B5 according to any one of aspects B1 to B4, the support aperture comprises an elongate shape comprising an aperture length measured along an aperture axis extending between a first end of the support aperture proximate a junction between the first strut and the seal support and a second end of the support aperture proximate a junction between the second strut and the seal support, wherein the aperture length is greater than a support cage height measured between the first strut and the second strut in a direction transverse to the cage axis.

In aspect B6 according to aspect B5, the aperture axis forms an included angle with the cage axis of less than 90 degrees, 85 degrees or less, 80 degrees or less, 75 degrees or less, 70 degrees or less, 65 degrees or less, 60 degrees or less, or 45 degrees or less.

In aspect B7 according to aspect B6, the included angle between the aperture axis and the cage axis is 45 degrees or more, 60 degrees or more, 65 degrees or more, 70 degrees or more, or 75 degrees or more.

In aspect B8 according to any one of aspects B1 to B7, a length of the first strut between the seal support and the distal end of the first strut is greater than a height of the support cage measured between the first strut and the second strut in a direction transverse to the cage axis.

In aspect B9 according to any one of aspects B1 to B18, the filter seal comprises an elongate shape comprising a seal length measured along a seal axis extending between a first end of the filter seal proximate the first edge of the filter body and a second end of the filter seal proximate the second edge of the filter body, wherein the seal length is greater than a filter body height measured between the first edge and the second edge along the filter height axis.

In aspect B10 according to aspect B9, the seal axis forms an included angle with the filter axis of less than 90 degrees, 85 degrees or less, 80 degrees or less, 75 degrees or less, 70 degrees or less, 65 degrees or less, 60 degrees or less, or 45 degrees or less.

In aspect B11 according to claim aspect B10, the included angle between the seal axis and the filter axis is 45 degrees or more, 60 degrees or more, 65 degrees or more, 70 degrees or more, or 75 degrees or more.

In aspect B12 according to any one of aspects B9 to B11, a length of the first edge of the filter body between the closed end and the filter seal is greater than a height of the filter body measured between the first edge and the second edge along the filter height axis.

In aspect B13 according to any one of aspects B9 to B12, the filter body comprises a filter body height measured between the first edge and the second edge along the filter height axis, and wherein the filter body comprises a filter body width measured between the first major side and the second major side of the filter body in a direction that is transverse to both the filter axis and the filter height axis, wherein the filter body width is 0.25 or less, 0.2 or less, or 0.1 or less times the filter body height.

In independent aspect C1, a collector for removing particulate matter from gas as described herein includes: a tubesheet comprising a clean face and a dirty face; a housing operably attached to the tubesheet, wherein the housing defines a clean air volume bounded in part by the tubesheet, wherein the clean face of the tubesheet faces the clean air volume; a plurality of apertures formed through the tubesheet, wherein each aperture of the plurality of apertures comprises an elongated aperture comprising a length extending along an aperture axis that is greater a width of the aperture measured in a direction transverse to the aperture axis, wherein, for each aperture of the plurality of apertures, a distance between the clean face of the tubesheet surrounding each aperture and a reference plane oriented transverse to the central pulse axis passing through the aperture changes when moving along the aperture axis; a pulse apparatus located in the clean air volume, the pulse apparatus configured to deliver pulsed gas through the plurality of apertures in the tubesheet, wherein the pulse apparatus defines a central pulse axis extending through each aperture of the plurality of apertures in the tubesheet; and a filter positioned in each aperture of the plurality of apertures. Each filter comprises a filter body attached to a filter seal: wherein the filter body comprises an envelope-shaped filter body that comprises filter media defining an interior volume within the filter, the filter body comprising an open end and a closed end, the filter body extending along a filter axis that extends between the open end and the closed end of the filter body, the filter body defining a first major side and a second major side, wherein the first major side and the second major side are defined by the closed end and the open end of the filter body when moving along the filter axis and wherein the first major side and the second major side are further defined by a first edge and a second edge when moving along the filter axis between the open end and the closed end, the first edge and the second edge extending from the closed end to the open end of the filter body; wherein the filter seal is positioned around a perimeter of the open end of the filter body and compressed against the clean face of the tubesheet to form a seal with the clean face of the tubesheet when the filter is installed in a selected aperture of the plurality of apertures such that gas passing into the interior volume must pass through the filter media or through the filter opening; wherein the first edge of the filter body is shorter than the second edge of the filter body and/or wherein, for each aperture of the plurality of apertures, the aperture axis and the reference plane oriented transverse to the central pulse axis passing through the aperture form an included angle of 5 degrees or more, 10 degrees or more, 15 degrees or more, 20 degrees or more, 25 degrees or more, 30 degrees or more, or 45 degrees or more.

In aspect C2 according to aspect C1, for each aperture of the plurality of apertures, the included angle between the aperture axis and the reference plane is 60 degrees or less, 45 degrees or less, 30 degrees or less, or 20 degrees or less.

In aspect C3 according to any one of aspects C1 to C2, the pulse apparatus comprises a plurality of jet tubes located in the clean air volume, wherein each jet tube of the plurality of jet tubes comprises a plurality of orifices configured to deliver air from the jet tube through a selected aperture of the plurality of apertures in the tubesheet.

In aspect C4 according to any one of aspects C1 to C3, the filter body comprises pleated filter media comprising pleats extending along the filter body from the filter seal to the closed end or a plurality of filter tubes.

In aspect C5 according to any one of aspects C1 to C3, for each filter positioned in an aperture of the plurality of apertures, a support cage of a filter support is positioned in the interior volume of the filter, the support cage attached to and extending away from a seal support along a cage axis aligned with the filter axis when the support cage is located in the interior volume of the filter and the filter seal is in contact with the seal support, wherein the seal support comprises a support aperture aligned with the filter opening and the aperture in the tubesheet when the support cage is located within the interior volume of the filter, and wherein the filter seal is compressed against the clean face of the tubesheet between the tubesheet and a filter side of the seal support such that gas passing into the interior volume through the filter opening passes through the support aperture of the seal support, and, optionally, wherein the support cage comprises a distal end proximate the closed end of the filter body when the filter seal is in contact with the seal support, wherein, when the support cage is located in the interior volume of the filter, the support cage comprises a first strut located proximate the first edge of the filter body and a second strut located proximate the second edge of the filter body, wherein the first strut extends from the seal support to a distal end proximate the closed end of the filter and the second strut extends from the seal support to a distal end proximate the closed end of the filter.

In independent aspect D1, a collector for removing particulate matter from gas as described herein includes: a tubesheet comprising a clean face and a dirty face; a housing operably attached to the tubesheet, wherein the housing defines a clean air volume bounded in part by the tubesheet, wherein the clean face of the tubesheet faces the clean air volume; a plurality of apertures formed through the tubesheet, wherein each aperture of the plurality of apertures comprises an elongated aperture comprising a length extending along an aperture axis that is greater a width of the aperture measured in a direction transverse to the aperture axis; and a pulse apparatus located in the clean air volume, the pulse apparatus configured to deliver pulsed gas through the plurality of apertures in the tubesheet, wherein the pulse apparatus defines a central pulse axis extending through each aperture of the plurality of apertures in the tubesheet. For each aperture of the plurality of apertures, the collector comprises a tubesheet adapter positioned on the clean face of the tube sheet in the clean air volume, the tubesheet adapter comprising a sleeve extending between a base opening and a receiving opening and a platform located in the sleeve, wherein the platform defines an effective clean face within the sleeve and a platform aperture located within the sleeve, and wherein the platform aperture comprises an elongated aperture extending along a platform aperture axis and wherein the central pulse axis extends through the platform aperture. For each tubesheet adapter, a distance between platform surrounding each platform aperture and a reference plane oriented transverse to the central pulse axis passing through the platform aperture changes when moving along the platform aperture axis.

In aspect D2 according to aspect D1, for each platform aperture, the platform aperture axis and the reference plane oriented transverse to the central pulse axis passing through the platform aperture form an included angle of 5 degrees or more, 10 degrees or more, 15 degrees or more, 20 degrees or more, 25 degrees or more, 30 degrees or more, or 45 degrees or more and wherein, optionally, the included angle between the aperture axis and the reference plane is 60 degrees or less, 45 degrees or less, 30 degrees or less, or 20 degrees or less.

In aspect D3 according to any one of aspects D1 to D2, the pulse apparatus comprises a plurality of jet tubes located in the clean air volume, wherein each jet tube of the plurality of jet tubes comprises a plurality of orifices configured to deliver air from the jet tube through a selected aperture of the plurality of apertures in the tubesheet.

In aspect D4 according to any one of aspects D1 to D3, the housing defines a dirty air volume bounded in part by the dirty face of the tubesheet such that the collector comprises an encased collector in which filter bodies of filters located in the collector are located in the dirty air volume.

In aspect D5 according to any one of aspects D1 to D3, the housing does not define a dirty air volume such that the collector comprises an insertable collector configured to be fitted to an enclosed volume such as a bin or silo.

In aspect D6 according to any one of aspects D1 to D5, a filter as described herein or a filter assembly as described herein is located within each platform aperture of the plurality of adapters, and the central pulse axis passing through each platform aperture is aligned with the filter axis of each filter or filter assembly located in the platform aperture.

Independent aspect E1 includes methods of removing particulate matter using any of the collectors described herein.

In independent aspect F1, a filter support as described herein includes a seal support and venturi attached to a support cage. The support cage extends away from the seal support along a cage axis and is configured for placement within an interior volume of an envelope-shaped filter. The seal support comprises a support aperture, wherein the cage axis extends through the support aperture. The venturi is configured to direct gas into an interior volume of an envelope-shaped filter in which the support cage is placed. The venturi extends between a collector opening facing away from the support cage and a filter opening facing the support cage, wherein the collector opening comprises an elongated collector opening extending from a first end to a second end along a venturi axis, wherein the venturi comprises a first depth proximate the first end that is greater than a second depth proximate the second end, wherein the first depth is measured between the first end of the collector opening and the seal support in a direction along the cage axis and the second depth is measured between the second end of the collector opening and the seal support in a direction aligned with the cage axis.

In aspect F2 according to aspect F1, the support aperture of the seal support comprises an elongate shape comprising an aperture length measured along an aperture axis extending between a first end of the support aperture and a second end of the support aperture. The venturi axis forms an included angle with the aperture axis of 5 degrees or more, 10 degrees or more, 15 degrees or more, 30 degrees or more, or 45 degrees or more, and optionally, wherein the included angle between the venturi axis and the aperture axis is 60 degrees or less, 45 degrees or less, or 30 degrees or less.

In aspect F3 according to aspect F1, the support cage comprises a first strut extending away from the seal support proximate the first end of the support aperture and a second strut extending away from the seal support proximate the second end of the support aperture. The aperture length is greater than a support cage height measured between the first strut and the second strut in a direction transverse to the cage axis.

In independent aspect G40, a collector as described herein may include a housing defining a clean air chamber between a first panel and a second panel; a filter aperture located in a tubesheet section of the first panel; an access aperture located in an access section of the second panel, where a first portion of the clean air chamber is located between the tubesheet section of the first panel and the access section of the second panel; an access cover closing the access aperture; a filter positioned in the filter aperture, wherein clean air entering the first portion of the clean air chamber through the filter aperture must pass through the filter, wherein the filter comprises a distal end located distal from the filter aperture, wherein a filter axis extends through the filter aperture and the distal end, the filter axis passing through the first portion of the clean air chamber and the access section of the second panel; a second portion of the clean air chamber located between the first panel and the second panel, wherein the second portion of the clean air chamber is adjacent the first portion of the clean air chamber; and a clean air outlet in direct fluid communication with the second portion of the clean air chamber, wherein the clean air entering the first portion of the clean air chamber passes into the second portion of the clean air chamber before leaving the clean air chamber.

In aspect G41 according to aspect G40, the collectors described herein include a filter as described herein.

In aspect G42 according to aspect G40, the collectors described herein include a filter assembly according to any one of aspects B1-B13.

In aspect G43 according to any one of aspects G40 to G42, the clean air outlet is located in an exhaust section of the second panel. The exhaust section is located adjacent the access section of the second panel.

In aspect G44 according to any one of aspects G40 to G43, the filter axis extends through the access aperture.

In aspect G45 according to any one of aspects G40 to G44, the filter axis does not extend through the second portion of the clean air chamber.

In aspect G46 according to any one of aspects G40 to G45, the filter aperture includes a first filter aperture of a plurality of filter apertures located in the tubesheet section of the first panel, and the filter comprises a first filter of a plurality of filters positioned in the plurality of filter apertures, and the filter axis comprises a first filter axis of a plurality of filter axes extending through the plurality of filter apertures, the plurality of filter axes passing through the first portion of the clean air chamber and the access section of the second panel.

In aspect G47 according to any one of aspects G40 to G46, the collector further includes a fan enclosure coupled to the housing proximate the exhaust section of the second panel. The fan enclosure includes a fan air inlet fluidically coupled to the clean air outlet; a fan air outlet fluidically coupled to an ambient environment; a fan mounted within the fan enclosure proximal to the fan air inlet; and a motor coupled to the fan and configured to power the fan to draw air from the clean air outlet towards the ambient environment.

In aspect G48 according to any one of aspects G40 to G47, the collector further includes a jet tube extending along a jet tube axis positioned within the clean air chamber. The jet tube axis is substantially parallel to a surface area of the first panel, and the jet tube comprises a lateral opening towards the filter aperture. Optionally, the jet tube comprises a first jet tube of a plurality of jet tubes positioned within the clean air chamber. Optionally the lateral opening comprises a first lateral opening of a plurality of lateral openings positioned on the plurality of jet tubes.

In aspect G49 according to any one of aspects G40 to G48, the collector further includes a filter housing coupled to the tubesheet section of the first panel, and the filter housing defines a dirty air chamber containing the filter.

In aspect G50 according to any one of aspects G40 to G49, the filter defines a filter length along the filter axis between and including the distal end and the filter aperture in the tubesheet section, and the first portion of the clean air chamber defines a first portion depth along the filter axis between and including the filter aperture in the tubesheet section of the first panel and an access opening in the access portion of the second panel, and the first portion depth is less than half of the filter length.

In aspect G51 according to aspect G50, the first portion depth is 25% or less of the filter length.

In aspect G52 according to any one of aspects G40 to G51, the filter aperture includes a first filter aperture of a plurality of filter apertures located in the tubesheet section of the first panel, and the filter includes a first filter of a plurality of filters positioned in the plurality of filter apertures, and the filter axis includes a first filter axis of a plurality of filter axes extending through the plurality of filter apertures, the plurality of filter axes passing through the first portion of the clean air chamber and the access section of the second panel, and each filter of the plurality of filters defines a filter length along the respective filter axis between and including the distal end and the filter aperture in the tubesheet section, and the first portion of the clean air chamber defines a first portion depth along each of the filter axes between and including the filter aperture in the tubesheet section of the first panel and the access opening in the access portion of the second panel, and the first portion depth is less than half of the filter length of any one of the filters.

The complete disclosure of the patents, patent documents, and publications cited herein are incorporated by reference in their entirety as if each were individually incorporated. In the event that any inconsistency exists between the disclosure of the present application and the disclosure(s) of any document incorporated herein by reference, the disclosure of the present application shall govern.

Illustrative embodiments of filtration systems and methods are discussed herein some possible variations have been described. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof. It should also be understood that this invention also may be suitably practiced in the absence of any element not specifically disclosed as necessary herein.

1. A collector for removing particulate matter from gas, the collector comprising:
a tubesheet comprising a clean face and a dirty face;
a housing operably attached to the tubesheet, wherein the housing defines a clean air volume bounded in part by the tubesheet, wherein the clean face of the tubesheet faces the clean air volume;
a plurality of apertures formed through the tubesheet, wherein each aperture of the plurality of apertures comprises an elongated aperture comprising a length extending along an aperture axis that is greater a width of the aperture measured in a direction transverse to the aperture axis, wherein, for each aperture of the plurality of apertures,
a pulse apparatus located in the clean air volume, the pulse apparatus configured to deliver pulsed gas through the plurality of apertures in the tubesheet, wherein the pulse apparatus defines a central pulse axis extending through each aperture of the plurality of apertures in the tubesheet, and wherein a distance between the clean face of the tubesheet surrounding each aperture and a reference plane oriented transverse to the central pulse axis passing through the aperture changes when moving along the aperture axis; and
a filter positioned in each aperture of the plurality of apertures, wherein each filter comprises a filter body attached to a filter seal:
wherein the filter body comprises an envelope-shaped filter body that comprises filter media defining an interior volume within the filter, the filter body comprising an open end and a closed end, the filter body extending along a filter axis that extends between the open end and the closed end of the filter body, the filter body defining a first major side and a second major side, wherein the first major side and the second major side are defined by the closed end and the open end of the filter body when moving along the filter axis and wherein the first major side and the second major side are further defined by a first edge and a second edge when moving along the filter axis between the open end and the closed end, the first edge and the second edge extending from the closed end to the open end of the filter body;
wherein the filter seal is positioned around a perimeter of the open end of the filter body and compressed against the clean face of the tubesheet to form a seal with the clean face of the tubesheet when the filter is installed in a selected aperture of the plurality of apertures such that gas passing into the interior volume must pass through the filter media or through the filter opening;
wherein, for each aperture of the plurality of apertures, the aperture axis and the reference plane oriented transverse to the central pulse axis passing through the aperture form an included angle of 5 degrees or more.

2. A collector according to claim 1, wherein, for each aperture of the plurality of apertures, the included angle between the aperture axis and the reference plane is 60 degrees or less.

3. A collector according to claim 1, wherein the first edge of the filter body is shorter than the second edge of the filter body.

4. A collector according to claim 1, wherein a length of the first edge of the filter body between the closed end and the filter seal is greater than a height of the filter body measured between the first edge and the second edge along a filter height axis.

5. A collector according to claim 1, wherein the seal axis forms an included angle with the filter axis of less than 90 degrees.

6. A collector according to claim 5, wherein the included angle between the seal axis and the filter axis is 45 degrees or more.

7. A collector according to claim 1, wherein the closed end of the filter extends along a closed end axis that is transverse to the filter axis and aligned with a filter height axis.

8. A collector according to claim 1, wherein the filter body comprises a filter body height measured between the first edge and the second edge along a filter height axis, and wherein the filter body comprises a filter body width measured between the first major side and the second major side of the filter body in a direction that is transverse to both the filter axis and the filter height axis, wherein the filter body width is 0.25 or less, times the filter body height.

9. A collector according to claim 1, wherein, for at least one filter positioned in an aperture of the plurality of apertures, a support cage of a filter support is positioned in the interior volume of the filter, the support cage attached to and extending away from a seal support along a cage axis aligned with the filter axis when the support cage is located in the interior volume of the filter and the filter seal is in contact with the seal support,
wherein the seal support comprises a support aperture aligned with the filter opening and the aperture in the tubesheet when the support cage is located within the interior volume of the filter,
and wherein the filter seal is compressed against the clean face of the tubesheet between the tubesheet and a filter side of the seal support such that gas passing into the interior volume through the filter opening passes through the support aperture of the seal support.

10. A collector according to claim 1, wherein the filter body comprises pleated filter media comprising pleats extending along the filter body from the filter seal to the closed end or a plurality of filter tubes.

11. A filter comprising a filter body attached to a filter seal:
wherein the filter body comprises an envelope-shaped filter body that comprises filter media defining an interior volume within the filter, the filter body comprising an open end and a closed end, the filter body extending along a filter axis that extends between the open end and the closed end of the filter body, the filter body defining a first major side and a second major side, wherein the first major side and the second major side are defined by the closed end and the open end of the filter body when moving along the filter axis and wherein the first major side and the second major side are further defined by a first edge and a second edge when moving along the filter axis between the open end and the closed end, the first edge and the second edge extending from the closed end to the open end of the filter body, wherein the filter body comprises pleated filter media comprising pleats extending along the filter body from the filter seal to the closed end or a plurality of filter tubes;
wherein the filter seal is positioned around a perimeter of the open end of the filter body and configured to form a seal with a seal surface when the filter is installed in an aperture of a tubesheet such that gas passing into the interior volume must pass through the filter media or through the filter opening;
and wherein the first edge of the filter body is shorter than the second edge of the filter body.

12. A filter according to claim 11, wherein the filter seal comprises an elongate shape comprising a seal length measured along a seal axis extending between a first end of the filter seal proximate the first edge of the filter body and a second end of the filter seal proximate the second edge of the filter body, wherein the seal length is greater than a filter body height measured between the first edge and the second edge along the filter height axis.

13. A filter comprising a filter body attached to a filter seal:
wherein the filter body comprises an envelope-shaped filter body that comprises filter media defining an interior volume within the filter, the filter body comprising an open end and a closed end, the filter body extending along a filter axis that extends between the open end and the closed end of the filter body, the filter body defining a first major side and a second major side, wherein the first major side and the second major side are defined by the closed end and the open end of the filter body when moving along the filter axis and wherein the first major side and the second major side are further defined by a first edge and a second edge when moving along the filter axis between the open end and the closed end, the first edge and the second edge extending from the closed end to the open end of the filter body, wherein the filter body comprises pleated filter media comprising pleats extending along the filter body from the filter seal to the closed end or a plurality of filter tubes;
wherein the filter seal is positioned around a perimeter of the open end of the filter body and configured to form a seal with a seal surface when the filter is installed in an aperture of a tubesheet such that gas passing into the interior volume must pass through the filter media or through the filter opening;
wherein the filter seal comprises an elongate shape comprising a seal length measured along a seal axis extending between a first end of the filter seal proximate the first edge of the filter body and a second end of the filter seal proximate the second edge of the filter body,
wherein the seal length is greater than a filter body height measured between the first edge and the second edge along the filter height axis;
and wherein the seal axis forms an included angle with the filter axis of less than 90 degrees.

14. A filter according to claim 12, wherein the seal axis forms an included angle with the filter axis of less than 90 degrees.

15. A filter according to claim 11, wherein the closed end of the filter extends along a closed end axis that is transverse to the filter axis and aligned with a filter height axis,

16. The collector according to claim 9, wherein the support cage comprises a distal end proximate the closed end of the filter body when the filter seal is in contact with the seal support, wherein, when the support cage is located in the interior volume of the filter, the support cage comprises a first strut located proximate the first edge of the filter body and a second strut located proximate the second edge of the filter body, wherein the first strut extends from the seal support to a distal end proximate the closed end of the filter and the second strut extends from the seal support to a distal end proximate the closed end of the filter.

17. A filter according to claim 11, wherein a length of the first edge of the filter body between the closed end and the filter seal is greater than a height of the filter body measured between the first edge and the second edge along a filter height axis.

18. A filter according to claim 13, wherein the seal axis forms an included angle with the filter axis of less than 90 degrees.

19. A filter according to claim 13, wherein the closed end of the filter extends along a closed end axis that is transverse to the filter axis and aligned with the filter height axis.

20. A filter according to claim 11, wherein the filter body comprises a filter body height measured between the first edge and the second edge along a filter height axis, and wherein the filter body comprises a filter body width measured between the first major side and the second major side of the filter body in a direction that is transverse to both the filter axis and the filter height axis, wherein the filter body width is 0.25 or less times the filter body height.

21. A filter according to claim 13, wherein the filter body comprises a filter body height measured between the first edge and the second edge along the filter height axis, and wherein the filter body comprises a filter body width measured between the first major side and the second major side of the filter body in a direction that is transverse to both the filter axis and the filter height axis, wherein the filter body width is 0.25 or less times the filter body height.
